(19) United States
(12) Patent Application Publication
(10) Pub. No.: US 2025/0344251 A1
(43) Pub. Date: Nov. 6, 2025

(54) METHODS AND APPARATUS FOR RANDOM ACCESS IN AMBIENT INTERNET OF THINGS (AIOT) SYSTEMS

(71) Applicant: InterDigital Patent Holdings, Inc., Wilmington, DE (US)

(72) Inventors: Martino Freda, Laval (CA); Paul Marinier, Brossard (CA); Moon IL Lee, Melville, NY (US); Jongwoo Hong, New York, NY (US); Brian Martin, Farnham (GB); Remun Koirala, London (GB); Erdem Bala, East Meadow, NY (US)

(73) Assignee: InterDigital Patent Holdings, Inc., Wilmington, DE (US)

(21) Appl. No.: 18/656,530

(22) Filed: May 6, 2024

(51) Int. Cl. H04W 74/0833; G16Y 10/75; H04W 88/04

(52) U.S. Cl. CPC H04W 74/0833; G16Y 10/75; H04W 88/04

(57) ABSTRACT

A WTRU may be configured as an intermediate node. The WTRU may receive, from a network, device IDs for inventory. The WTRU may determine access occasions of first type reserved for devices using a first type of access procedure and access occasions of second type reserved for devices using a second type of access procedure. The WTRU may transmit an inventory initiation message to the devices, including information on the access occasions of first type and of second type. The WTRU may receive, during an access occasion of first type, a first message from a first device, including a first type of device ID. The WTRU may receive, during an access occasion of second type, a second message from a second device, including a second type of device ID. The first message may include data. The WTRU may assign a first type of device ID to the second device.

### BACKGROUND

In recent years, Internet of Things (IoT) has attracted much attention in the wireless communication world. More ‘things’ are expected to be interconnected for improving productivity efficiency and increasing comforts of life. Further reduction of size, complexity, and power consumption of IoT devices may enable the deployment of tens or even hundreds of billions of IoT devices for various applications and provide added value across the entire value chain. Manual replacement of batteries in IoT devices may lead to high maintenance cost, environmental issues, and even safety hazards for some use cases (e.g., wireless sensor in electric power and petroleum industry).

Considering the limited size and complexity required by practical applications for battery-less devices with no energy storage capability or devices with limited energy storage that do not need to be replaced or recharged manually, the output power of energy harvester is typically from 1 μW to a few hundreds of μW. Existing cellular devices may present peak power consumption of orders higher than 10 mW, adding a challenge when utilizing cellular devices for IoT applications that may require extremely low power consumption.

### SUMMARY

In an Ambient IoT (AIoT) system, an AIoT device, such as a tag, may communicate with an intermediate node, which may be, e.g., a relay, a WTRU, a UE, or an IAB node. The intermediate node may communicate with the base station, processing and/or relaying information associated with one or more AIoT devices. The intermediate node may have the capability of communicating directly with the AIoT device, over the AIoT interface, e.g., using RFID. The intermediate node may process and then relay the information between the base station and the AIoT device. The communication between the nodes may be bidirectional, allowing for data and/or signaling in both directions.

A WTRU may be configured to perform the functions of a reader or an intermediate WTRU. The WTRU may page an AIoT device to request information, such as during an inventory procedure. To respond to the request, the AIoT device may perform an access procedure. To enable AIoT devices to respond to requests and/or initiate communication with the WTRU, the access procedure may be defined.

A system may provide different types of access procedures, e.g., a UE in a 5G system may use a 2-step random access procedure or a 4-step random access procedure. In this case, the access procedure is characterized based on number of steps. However, access procedures may be characterized based on other factors, such as the contention model used, e.g., a contention-based versus a contention-free model. Methods to categorize access procedures into different types are described.

When different types of access procedures are available to the AIoT device, the AIoT device may select one type and attempt to access the system. To facilitate the access type selection, the WTRU may provide information to the AIoT device. The information may be provided in a static manner (e.g., once), semi static (e.g., it is provided once, but it may be reconfigured), or dynamic (e.g., provided in (every) paging message). The information provided may include configuration parameters to assist the AIoT device in the selection of an access type or (near) real-time information about the current conditions of the system.

In one example, the WTRU may use several factors associated with the system and the AIoT devices that are currently in the system to determine the most appropriate type of access procedure to use. The WTRU may indicate, to the AIoT device, the determined type, e.g., in the paging message. Methods, for an AIoT device and/or a WTRU reader, to determine which type of access procedure to use during a specific access attempt are described. Solutions on how to determine physical resources to be used in a specific access attempt are also described.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a diagram illustrating an example communications system in which one or more disclosed embodiments may be implemented;

FIG. 1B is a system diagram illustrating an example WTRU;

FIG. 1C is a system diagram illustrating the RAN and the CN according to an embodiment;

FIG. 1D is a system diagram illustrating the RAN and the CN according to an embodiment;

FIG. 2 illustrates an example of a call flow of an asset identification procedure using RFID devices;

FIG. 3 illustrates an example of call flows of two types of random access procedures that may be used in 5G New Radio (NR) systems;

FIG. 4 depicts the architecture of an example of a topology of an AIoT system—Topology 1;

FIG. 5 depicts the architecture of another example of a topology of an AIoT system—Topology 2;

FIG. 6 depicts the architecture of another example of a topology of an AIoT system—Topology 3;

FIG. 7 illustrates a flow chart of an example of a process for selecting an access type to use based on two factors: number of devices being paged and total available access resources;

FIG. 8 illustrates a flow chart of an example of a process for an access type reselection;

FIG. 9 illustrates a flow chart of an example of a process for selecting an access type to use base on a combination of factors at different levels;

FIG. 10 illustrates a flow chart of an example of a procedure to determine the access type selection process;

FIG. 11 illustrates a call flow of an example of an intermediate WTRU triggering an inventory procedure;

FIG. 12 illustrates a call flow of an example of an intermediate WTRU providing access occasion type configuration during an inventory procedure; and

FIG. 13 illustrates an example of a method to be performed by an intermediate WTRU.

### DETAILED DESCRIPTION

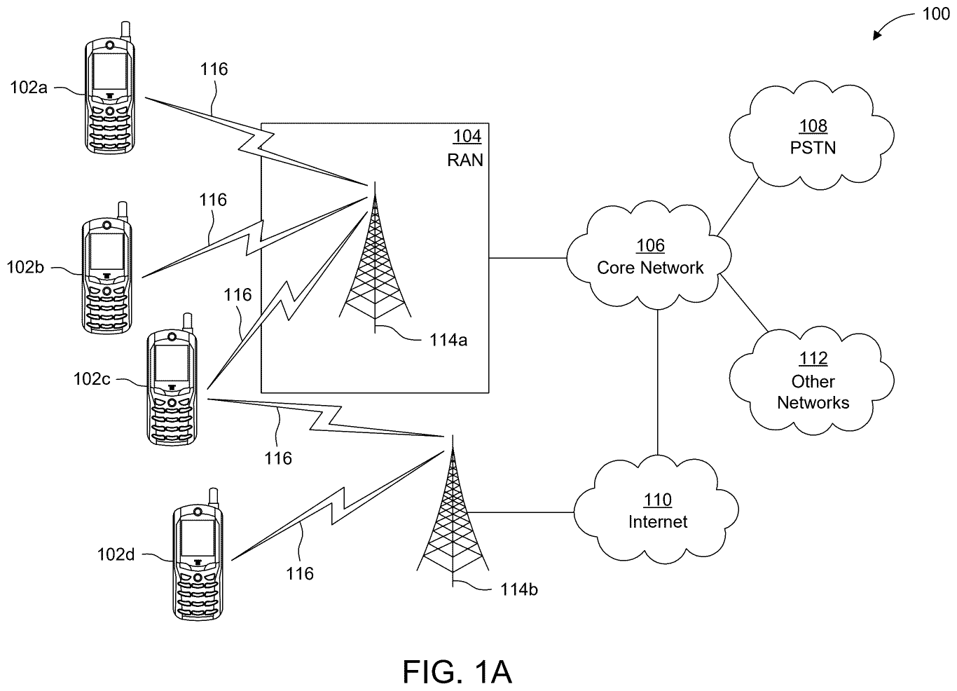

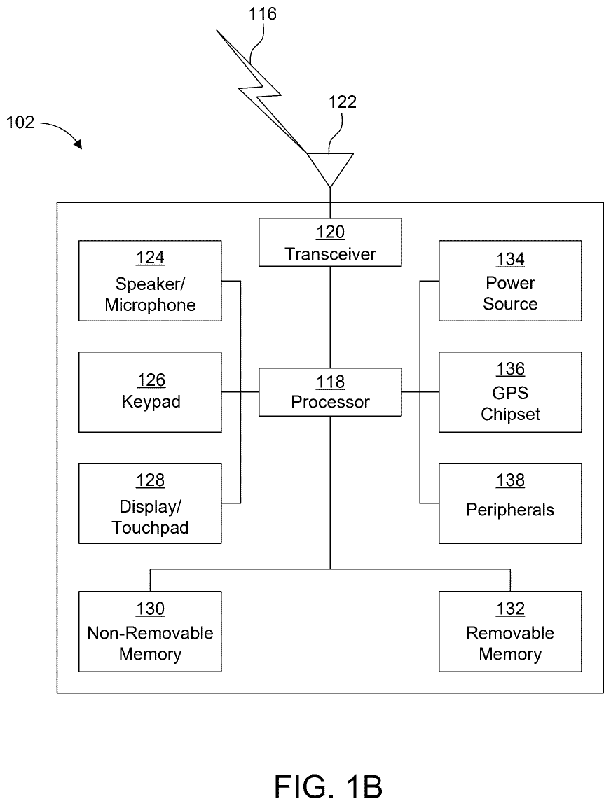

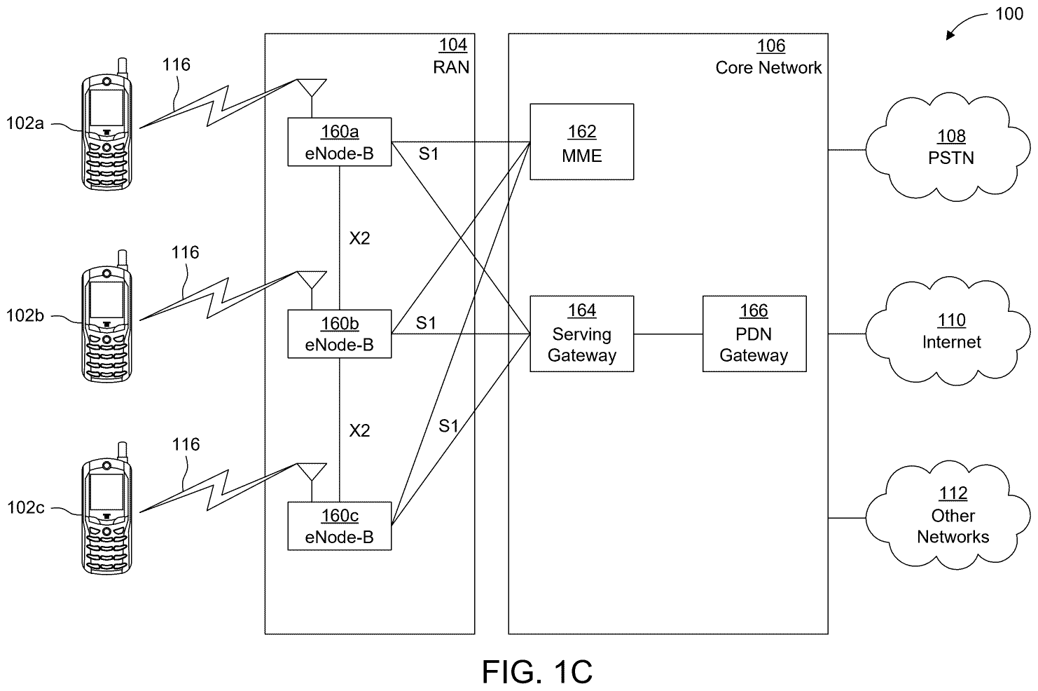

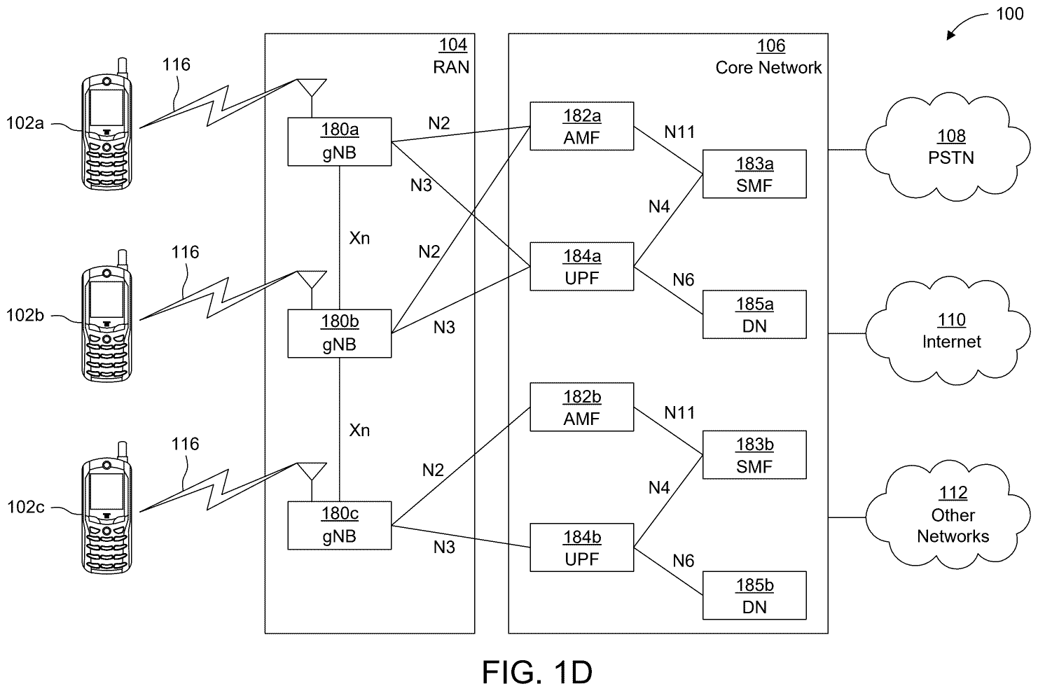

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In recent years, Internet of Things (IoT) has attracted much attention in the wireless communication world. More ‘things’ are expected to be interconnected for improving productivity efficiency and increasing comforts of life. Further reduction of size, complexity, and power consumption of IoT devices may enable the deployment of tens or even hundreds of billions of IoT devices for various applications and provide added value across the entire value chain. Manual replacement of batteries in IoT devices may lead to high maintenance cost, environmental issues, and even safety hazards for some use cases (e.g., wireless sensor in electric power and petroleum industry).

Considering the limited size and complexity required by practical applications for battery-less devices with no energy storage capability or devices with limited energy storage that do not need to be replaced or recharged manually, the output power of energy harvester is typically from 1 μW to a few hundreds of μW. Existing cellular devices may present peak power consumption of orders higher than 10 mW, adding a challenge when utilizing cellular devices for IoT applications that may require extremely low power consumption.

An example type of application is asset identification, which presently has to resort mainly to barcode and RFID in most industries. The main advantage of these two technologies is the ultra-low complexity and small form factor of the tags. However, the limited reading range of a few meters usually requires handheld scanning, which may lead to labor intensive and time-consuming operations, or RFID portals/gates, which may lead to costly deployments. In addition, the lack of interference management schemes may result in severe interference between RFID readers and capacity problems, especially in case of dense deployments. It may be difficult to support large-scale network with seamless coverage for RFID.

Radio Frequency Identification (RFID) systems are Internet of Things (IoT) systems comprising two types of devices, referred to as “tags” and “readers” or “interrogators”. RFID devices have at least one antenna that is used by the device to communicate with each other using signals. Different applications may take advantage of an RFID system such as inventory control, containers tracking, patient monitoring, pet finding, and children tracking, to name a few.

As an example, in an inventory control system, an interrogator device, may trigger multiple tag devices using a sequence of messages, to which the tag devices may respond to. In other words, the inventory procedure may comprise a single round of attempts of having each tag device respond or attempt to respond with its access ID or perform a random access procedure.

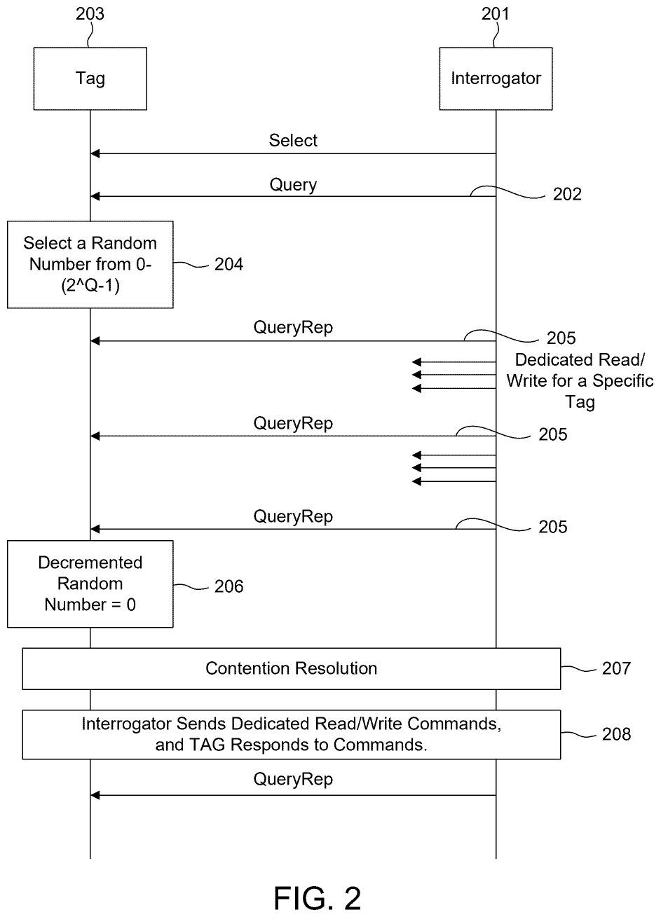

FIG. 2 illustrates an example of a call flow of an asset identification procedure using RFID devices.

In the inventory procedure, an interrogator or reader 201 may send a Query message 202 to energize all or a subset of tags 203. Following the Query message 202, the tag 203 may select a random number from 0-2\hat{ }Q-1 204 and load its memory with that number. At each transmission of a QueryRep 205, the tag 203 decrements its counter until the counter reaches 0 206. When the counter reaches 0 206, the tag 203 may initiate a contention resolution procedure 207, which may include transmitting its device ID in the uplink, and waiting for confirmation of the device ID in the downlink (to address possible collision between multiple devices selecting the same random number). The interrogator (or reader) 201 may send multiple read/write commands 208 to a tag 203 that has passed the contention resolution, to which the tag may respond 208.

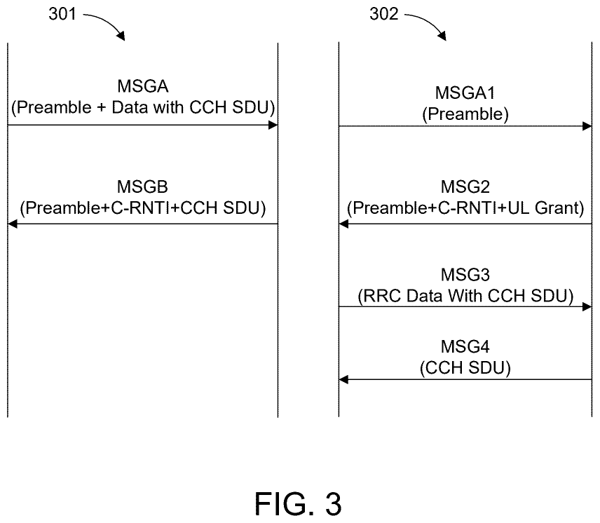

FIG. 3 illustrates an example of call flows of two types of random access procedures that may be used in 5G New Radio (NR) systems.

Random Access in 5G New Radio (NR) supports 2 types of random access procedures: 2-step 301 and 4-step 302 random access. A WTRU may decide between using 2-step 301 or 4-step 302 random access based on a number of factors.

A WTRU may decide between using 2-step 301 or 4-step 302 random access based on an RSRP threshold: If the cell level RSRP is above a threshold, the WTRU may use 2-step random access. The idea is that at cell center, 2-step random access may be sent because timing advance (TA) is minimal.

A WTRU may decide between using 2-step 301 or 4-step 302 random access based on history of previous attempts: If a number of 2-step procedures do not succeed, the WTRU may switch to a 4-step procedure. Specifically, the WTRU may be in cell center but the channel quality may not be sufficiently high to transmit data successfully.

A WTRU may decide between using 2-step 301 or 4-step 302 random access based on MSBB contents: If MSGB contains a fallback indication, and if the network is able to successfully decode the preamble, but not the data, then the procedure may continue as a 4-step random access procedure to recover the data after the TA is applied.

Ambient IOT (AIoT) may use RFID access as a baseline for its access mechanism. However, RFID access does not address the fact that two devices may randomly select the same occasion, and the same random number, in which case a collision may occur, and both devices may transmit their device ID (i.e., data) at the same time. This is because RFID uses only a single step of contention resolution. To design an access mechanism for ambient IoT (AIoT) that is more robust to a large number of devices, enhanced/additional contention resolution may be needed. It is desired to enhance the contention resolution without sacrificing device power consumption (e.g., due to excess of messages).

For AIoT, devices may need to be accessed periodically or in regular intervals, e.g., for tracking these devices. A mechanism for performing contention-free access of multiple devices may be designed to support this use case.

Different network topologies may be defined for an AIoT system.

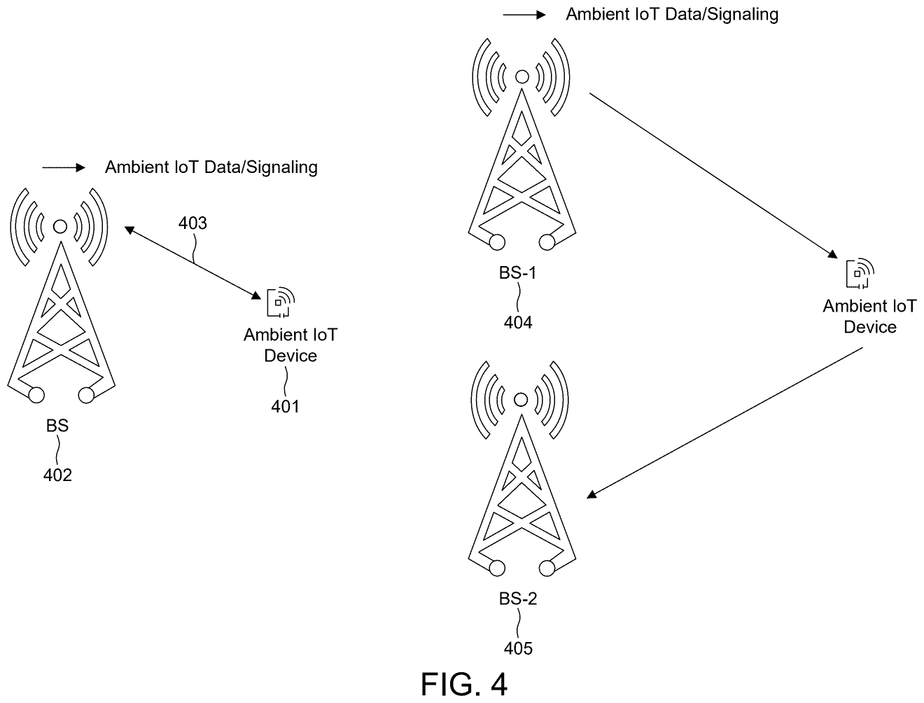

FIG. 4 depicts the architecture of an example of a topology of an AIoT system—Topology 1.

In topology 1, the AIoT device 401 may communicate with a base station (e.g., gNB, eNB) 402. The communication between the base station and the AIoT device may include data and/or signaling over the AIoT interface 403. In one example, the communication may be bidirectional, with one base station supporting the bidirectional communication. In another example, the communication may involve two base stations 404, 405, one base station 404 may be transmitting to a given AIoT device and another base station 405 may be receiving 405 from the same AIoT device.

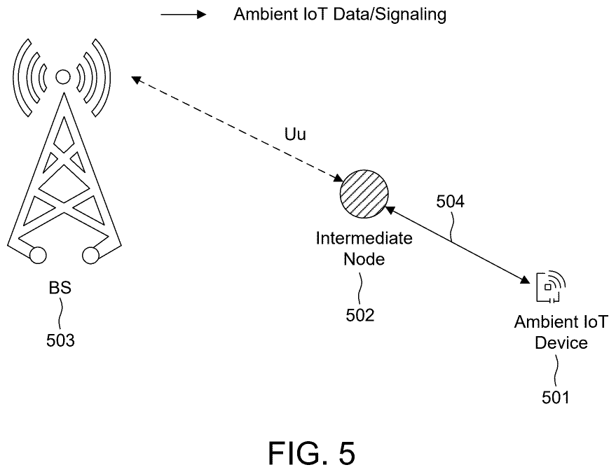

FIG. 5 depicts the architecture of another example of a topology of an AIoT system—Topology 2.

In topology 2, the AIoT device 501 may communicate with an intermediate node 502, and the intermediate node 502 may communicate with the base station 503. The intermediate node 502 may be, for example, a relay, an IAB node, a UE, an WTRU, or a repeater. The intermediate node may be referred to as intermediate WTRU. The intermediate WTRU 502 may have the capability of communicating with the base station (e.g., over the Uu interface) and of communicating directly with the AIoT device 501, over the AIoT interface 504 (e.g., using RFID). The intermediate WTRU 502 may process and then relay the information between the base station 503 and the AIoT device 501. The communication between the nodes may be bidirectional, allowing for data and/or signaling in both directions.

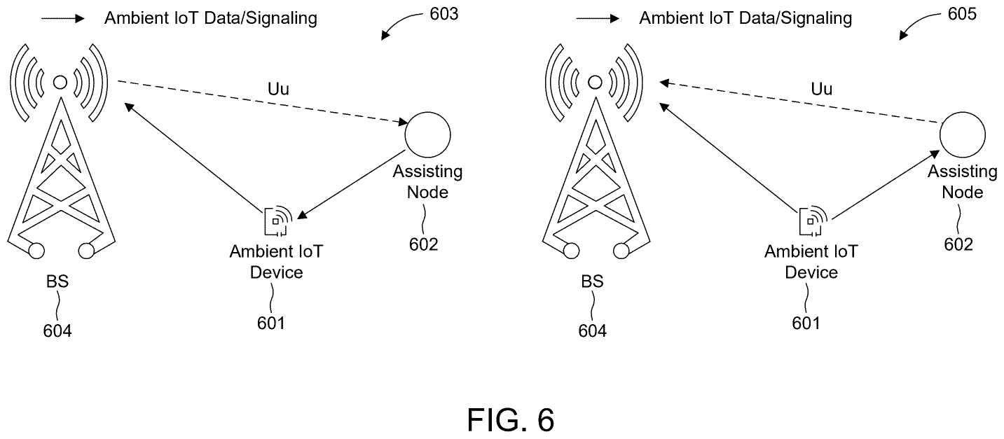

FIG. 6 depicts the architecture of another example of a topology of an AIoT system—Topology 3.

In topology 3, the AIoT device 601 may communicate using an assisting node 602. The assisting node 602 may be for example, a WTRU, a relay, an IAB, an UE, a repeater. The assisting node may be capable of AIoT communication. In one example, the assistance may be a downlink assistance 603. In the downlink assistance model, the AIoT 601 device may transmit data and/or signaling to the base station 604, and receive data and/or signaling from the assisting node 602. In another example, the assistance may be an uplink assistance 605. In the uplink assistance model, the AIoT device 601 may receive data and/or signaling from a base station 604 and transmit data and/or signaling to the base station and to the assisting node 602.

The term “reader” refers to the entity which queries the AIoT device, either directly, or via an intermediate node (e.g., WTRU, UE), as in topology 2. The term reader, in topology 2, may also refer to the intermediate WTRU. As a result, the term reader may refer to a network node or a WTRU, depending on the context and/or the topology.

The terms “reader,” “WTRU reader,” “intermediate node,” and “intermediate WTRU” are used interchangeably to mean the reader or an intermediate node, based on the scope of the solution being described.

The terms “device,” “tag,” and “AIoT WTRU” are used interchangeably to mean the AIoT device that is being inventoried/queried by the reader.

The term “inventory” refers to the overall procedure of a reader triggering access by multiple devices using a sequence of messages (e.g., similar to query, followed by query rep in RFID). Specifically, the inventory procedure refers to a single round of attempts to have each device respond or attempt to respond with its access ID, or perform a RACH procedure. Specifically, the inventory procedure refers to a set of access occasions which may have 0 or at least 1 device respond within the access occasion.

The inventory procedure may occur similar to legacy RFID procedure. Although referred to as inventory procedure, it may be termed differently in device requirements or specifications (e.g., query procedure, paging procedure).

The term “occasion” refers to the opportunity for device transmission that may be delimited by the transmission of a query rep message (or similar). Specifically, a device may perform transmission in an occasion by performing a AIoT transmission in a defined time following the query rep associated with that transmission. Alternatively, an occasion may consist of both a time aspect and a frequency aspect. Specifically, a device may determine an occasion as a transmission following a specific query rep, and by transmitting on one of a number of frequencies (e.g., FDM). Wherever solutions indicate selection of an occasion, they can apply equivalently to selection of only a time component and/or selection of a frequency component.

Any reference to “time” may indicate an absolute time measurement (e.g., seconds, slots, frames) or it may indicate a number of executions of a procedure, possibly triggered by a reader (e.g., number of inventory procedures, number of accesses or RACH procedures). Alternatively, it may indicate a number of messages, possibly of a specific type, or containing specific information, received or transmitted.

The terms “configuration” or “pre-configuration” may refer to any configuration received by a message (e.g., an RRC message, a MAC CE, a PHY layer signal, a data PDU, a control PDU associated with any existing or new protocol layer) received from either a network node, or from another device or UE or WTRU. The term pre-configuration may refer to the process of pre-provisioning information is a device or UE or WTRU.

The term “random access type” refers to the behavior associated with a device performing transmission associated with random access or initial access, possibly on the AIoT interface. A random access of one type may differ compared to random access of another type based on a combination of the factors.

The term “device ID” is used in the solutions' descriptions. The device ID may consist of a permanent device ID assigned to the device during provisioning, or configuration, or provided by the application layer. The device ID may be assigned by the base station (e.g., gNB), or assigned by an intermediate WTRU. For security and privacy reasons, the device ID used in the random access procedure may be an encrypted or encoded version of any of the possible device IDs.

Methods to categorize access procedures into different types of access procedure are described. Methods to determine which access type may be used in a specific access attempt are described, both for a device and for a WTRU reader, Methods to determine the physical resources to be used in a specific access attempt are described, both for a device or a WTRU reader. Both time division multiplexing (TDM) and frequency division multiplexing (FDM) are considered in the solutions. The solutions use 5G and RFID systems for clarity purposes, may they equally apply to other systems.

In one example, a WTRU may be configured to perform functions of a reader or of an intermediate WTRU. The WTRU may determine the number of access occasions that use a first type of access procedure (e.g., 2-step random access) or a second type of access procedure (e.g., a 4-step random access). The determination may be based on the number of known devices that are part of a network request and the total number of configured occasions.

The WTRU may be configured, by the network (e.g., in a first RRCReconfiguration message), with a set of access occasions (N) for an inventory round, and a set of parameters for determining the number of the occasions that use the first type of access procedure vs the second type access procedure (e.g., threshold values x1 and x2).

The WTRU may receive an inventory request (e.g., in a second RRCReconfiguration message), and the inventory request may indicate a set of device IDs of a first type (e.g., NAS or upper layer), or may indicate all devices to respond.

The WTRU may determine the number of device IDs of the first type in the indicated set of device IDs of the first type which correspond to devices which have previously responded to the WTRU and that have been assigned a device ID of a second type (e.g., AS layer ID) by the WTRU.

The WTRU may determine, based on the number of access occasions (N) and on the number of previously responding devices, a number of occasions associated with a first access type (and optionally a number of occasions associated with a second access type). In one example, if (number of previously responding devices)/(number of access occasions) is less than a threshold; the WTRU may determine x1 first access type occasions, otherwise, determine x2 first access type occasions. For example, determine the remaining N-x1 or N-x2 occasions to be second access type occasions.

The WTRU may transmit an inventory initiation message indicating the total number of occasions (N), the number of first type access occasions (e.g., the selected x1 or x2), or an explicit indication of the access type (first type or second type) associated with each access occasion, and an identifier associated with a group or all devices. In one example, the identifier may be a device ID of a first type with an associated mask indicating the bits of the device ID of the first type to consider when matching to the device ID of the first type. In another example, the identifier may be a list of device IDs of the first type. In another example, the identifier may indicate all devices that have an assigned device ID of a second type.

For each access occasion, the WTRU may transmit an occasion initiation message. If the access occasion corresponds to a first type of access occasion (e.g., occasion number is less than determined number of first type access occasions or the occasion is explicitly indicated as a first type access occasion), the WTRU may receive an access ID and corresponding data and, optionally, respond to the received message with the received data

Otherwise, if the access occasion corresponds to a second type of access occasion (e.g., occasion number is larger than or equal to the determined number of first type access occasion, or the occasion is explicitly indicated as a second type access occasion), perform one or more of the following actions: 1) receive an access ID, 2) select an unused device ID of a second type, and respond to the received message with the received access ID and the unused device ID of the second type, 3) receive data following the response, 4) assign the device to the selected device ID of the second type (for future inventory requests from the network), or 5) respond to the device with the received data.

A device may be configured by the reader, whereby the reader may be a network node or a WTRU (e.g., intermediate WTRU in topology 2). In the case of a WTRU, the WTRU may derive the device configuration itself, or receive the device configuration from the network, in which case, the device configuration is being relayed from the network to the device by the WTRU. The WTRU may also be pre-provisioned with information provided by the network or system operator or owner.

Messages associated with a random access procedure may be associated with any AIoT protocol layer or may comprise a combination of information associated with different protocol layers. The messages may contain information (e.g., WTRU ID, resource information) in a control element (CE), such as a MAC CE, an RRC message, or a control element of a new AIoT layer. The messages may contain data encapsulated into a protocol layer PDU (e.g., a MAC PDU, a PDCP PDU, a PDU associated with a new AIoT protocol layer). The messages may contain data containers containing transparent data from other layers, such as a NAS container, an RRC container, or PDU at the MAC layer comprising data transparently included from a higher layer.

Methods to categorize access procedures into different types of access procedure are described.

In one embodiment, a random access type may be defined based on the contents of any of the messages transmitted by the device (or received by the reader), e.g., MSG1, MSG3.

In one example, a content may be whether or not a specific message (e.g., MSG1) contains a specific information element. For example, a first random access type may contain data transmissions while a second random access type may not contain data transmissions. For example, a first random access type may include, in the first message, a specific field (e.g., explicit indicator) while the second random access type may not include that field in the message.

In another example, a content may be the type of information element included in the message. For example, a first random access type may contain a random number as a WTRU ID, while a second random access type may contain a device ID that was assigned to the WTRU.

In another example, a content may be the encapsulation method used to send the information in a message. For example, a first random access type may include the information in one layer, while a second random access type may include the information in another layer. For example, a first random access type may include the information in a first control element (e.g., a MAC CE, or a first MAC CE type) and a second random access type may include the information in a second control element (a different MAC CE, or a control element of a different layer or type

In another embodiment, a random access type may be defined based on with the contents of any of the messages received by the device (or transmitted by the reader), e.g., MSG2, MSG4.

In one example, a content may be whether or not a specific message (e.g., MSG2) contains a specific information element. For example, a first random access type may have MSG2 which contains only the same ID that was transmitted by the device (i.e., for contention resolution ID). A second random access type may have MSG2 which contains both the contention resolution ID and an additional ID and/or an indication of a resource.

In another embodiment, a random access type may be defined based on the number of messages transmitted by the device (e.g., until the random access is completed). For instance, the number of messages that are transmitted by the device and by the reader before the procedure is completed, i.e., before the device and/or the reader has determined which device has successfully accessed the system and may initiate data transmission.

In another embodiment, a random access type may be defined based on the trigger of the random access procedure (e.g., when the random access is initiated). For example, what message or condition(s) triggers the random access procedure.

In one example, the trigger of the random access may be data available for transmission at the device, while for a second type, the trigger of the random access may be a message received from the reader.

In another example, a device may trigger random access when the contents of a message sent by reader contains a first information element, while for a second type, a device may trigger random access when the contents of the message sent by the reader contains a second information element.

In another example, the device may have a first identity matching condition (e.g., ID in the message matches a first ID at the device) and for a second type, the device may have a second identity matching condition (e.g., ID in the message matches a second ID at the device).

In another embodiment, a random access type may be defined based on the resources used by the device and/or the reader to perform transmission of any of the messages (e.g., time and/or frequency and/or occasion).

For example, what resource (e.g., time, frequency, occasion) is used by the device and/or the reader to transmit any of the messages associated with the random access. This may include one or more of: which frequency resource to use, which occasion(s) to use or to select from, which slot within an occasion in which to transmit, or whether or not the transmission within an occasion should occupy a limited time (i.e., use slots within an occasion).

In another embodiment, a random access type may be defined based on the handling of failure conditions. The behavior may be associated with failure handling at the device or at the reader. In one example, the behaviour may be associated with actions to be taken by the device when a message is sent and no response is received. For instance, whether to perform retransmission, when to perform retransmission, what resources to use to perform retransmission, etc. In another example, this may include the behavior when a response does not contain the required information. For instance, how to handle contention resolution

In another embodiment, a random access type may be defined based on the transmission parameters or characteristics. For example, the use of a preamble, midamble, postamble; the transmission duration; the coding rate; or the transmit power.

Random access type may refer to a random access with one or a set of different contents of any of the messages transmitted or received during the random access procedure.

Random access type may refer to a random access where the method (transmit power, message type, message timing, resources used) to transmit any of the messages associated with the random access may be different between a first type and a second type.

An access procedure type may be defined based on the contention model, e.g., the access type may be contention-based on contention-free. In a contention-based multiple access, the devices do not have dedicated resources to transmit, and accordingly, their transmissions may collide (e.g., when 2 or more devices transmit at the same time). If the reader responds, the device may not know if the response is for itself or for another device. In this case of contention-based access, the device may determine whether a contention was successfully resolved based on receiving an “echo” from the reader. This may, for instance, be a parameter that was previously sent from the device to the reader, now being sent by the reader, which confirms to the device that the message from the reader is in response to the message the device previously sent to the reader, such as the two messages (sent and received) are associated and linked to each other.

A random access type may also be defined based on the number of steps (or messages) comprising the procedure. For example, a 2-step or 4-step random access require two messages or four messages, respectively. The access may be categorized based on both the number of steps and the contention model.

The 2-step and 4-step types of access procedures in the solutions detailed in the subsequent paragraphs may be considered to be contention-based access types, based on the description above. Other characteristics, such as the ones described in the previous paragraphs, may be further used as a basis to distinguish different types of access procedure. For example, a 2-step, contention based access type may also be characterized based on transmission parameters, e.g., modulation and coding scheme (MCS) used (different types of access may use different MCSs). E.g., one type may be a 2-step, contention-based, MCS-1 and another type may be a 2-step, contention-based, MCS-2.

As an example, one solution may include a 2-step random access. The procedure may comprise performing random access such that the first message by the device may contain data. In this type of access procedure, the device may transmit a single message to gain access to an access occasion, or to perform subsequent transmissions without additional contention.

In the 2-step random access procedure, the reader may send a paging message which may include one or more of: a single device ID, a list of device IDs, a group ID indicating a group (or subgroup) of WTRUs, or set of group IDs. In one example, the group or subgroup may be associated with the devices whose device IDs have common bits with the sent single device ID or with the sent list of device IDs. In one example, the group or subgroup may have been established previously, e.g., using previous messages or configuration by the reader.

The reader may send a “query-like” message, the message may contain a configuration of the resources for the random access, such as the number of access occasions, and the frequency, timeslot, symbol resources, possibly associated with each access occasion; an indication of the data being requested by the reader (e.g., requesting an application layer ID, or requesting application layer data).

The paging message and the query-like message may be different messages. They may be sent separately in 2 distinct transmissions. They may be concatenated and sent in a single physical transmission. The information of the two messages may be combined and sent all together in one message, e.g., send a query-like message with paging information added to it, or send a paging message with the configuration that would otherwise be included in the query-like message.

A device, upon receiving the reader message(s), may select a resource (e.g., access occasion, frequency, time slot, symbol resources) in which to transmit a first message.

The start of the resource (e.g., the access occasion) may be indicated by a message transmitted by the reader. This message may contain further information about the resources (e.g., symbol, timeslot, and/or frequency resources) associated with the access occasion. This message may contain further information about the random access associated with the access occasion, such as the random access types (e.g., 2-step, 4-step, etc.) allowed in the access occasion.

The device may transmit, upon receiving the message from the reader, and in the selected resource, a first message. The device may select a resource (e.g., access occasion, frequency, time slot, symbol resources) in which to transmit the first message.

The first message from the device may contain a random number, wherein the random number size (e.g., in number of bits) may be fixed. The random number size may be configured by the reader in one of the previous reader transmissions. The random number size may be determined by the device based on any of the factors described for determining the random access type.

The first message from the device may contain a device ID. The device ID may be a permanent ID assigned to the device. the device ID may be an upper layer (e.g., application layer) device ID, possibly assigned by the application communicating with the device. The device ID may be an AS layer device ID assigned by the reader. The device ID contained in the message may be a portion of any of the aforementioned device IDs, such as the MSB (most significant bits) or LSB (least significant bits), or a combination thereof. The device may be configured with a predefined number of bits of the device ID to send. The device may send as many bits of the device ID as it is able to transmit given some transmission constraints, e.g., constraints on the device's available energy, or constraints on the allowed transmission duration.

The first message from the device may contain a data element. A data element (or portion of a data element) may be provided by upper layers or application layer in response to information received in a previous message from the reader. The portion of the data element may be limited by the same factors as the device ID. The data element may contain, e.g., sensor data, list of events, or data associated with a memory location.

The device ID may be considered as a data element. For example, there may be 2 device IDs, one at the application layer and one at the radio layer. The application layer device ID may be (part of) the data element. Or the permanent device ID may be (part of) the data element.

For example, the portion of the device ID not included in the device ID “field”, may be added to a data element, when permissible (i.e., other data does not use all the available data element bits.

The reader, upon receiving the first message, may respond with a second message.

The second message may include the same random number that was received in the first message from the device. The second message may include the same device ID received in the first message from the device. The second message may include the same data element, or a subset of the same data element, received in the first message from the device.

The second message may include a subsequent command. The second message may include configuration information for resources to be used by the device to respond to the command message

The second message may include a newly assigned device ID, which may be used thereafter.

The device, upon receiving the second message from the reader, may consider the random access procedure to be successful based upon matching a given field sent in the first message (as exemplified above, e.g., device ID, random number, or other), with the received field in the second message.

If the device determines the random access procedure to be successful, it may respond to the command included in the second message from the reader, or to any subsequent command sent by the reader, without any contention resolution. The device may store the new device ID that was assigned by the reader.

In another example, in a 2-step random access procedure, the reader may send a paging message including an indication that any device should respond. The paging message may not contain a device ID or a group ID, indicating that it is addressed to all devices that receive that paging message. The paging message may contain the number of access occasions and the number of frequency resources per access occasion.

A device, upon receiving the paging message, may randomly select an access occasion, and a frequency, timeslot, symbol resource within that access occasion.

The device may transmit a first message in the selected access occasion and resources. The first message may contain a random number and a device ID. If the device has a stored device ID assigned by the reader, it may respond with its stored assigned device ID, otherwise, it may respond with (a portion of) the permanent device ID, or optionally with no device ID. The device may further include a data element in the message, where the type of data (e.g., device ID, sensor data, etc.), may be determined based on information in the paging message.

The reader, upon reception of the first message from the device, may transmit a second message. The second message may include, e.g., the random number received in the first message. The second message may include a command.

The device may consider contention resolution to be successful if it receives the second message and the random number in the first message matches the random number in the second message. In this case, the device may respond to the received command in the second message.

The device may now respond to any subsequent commands received from the reader, without performing any random access procedure. For example, the device may continue to transmit in the same access occasion, possibly in the same resources (frequency, timeslot, symbols). The device may continue to transmit data to the reader as long as it has additional data associated with a request that was received from the reader. The device may transmit until the access occasion ends. The device may also continue to receive requests from the reader, and respond accordingly.

In one solution, if the device has a stored device ID that was assigned by the reader, it may not include the random number. Otherwise, it may include the random number. If the device sends the first message with a device ID and no random number, the reader may send the second message with a device ID only. If the device sends the first message with a device ID and a random number, the reader may reply with the random number only, or both. Contention resolution at the device may be performed with either the random number or the device ID, based on what is transmitted by the reader. The device ID may be a permanent device ID or a previously assigned device ID.

In one solution, the reader may indicate in a reader transmission prior to the random access which of the device ID and/or random number to include.

In one solution, whether the device includes a device ID or a random number may depend on whether security has been established by upper layers (e.g., some upper layer message exchange has previously taken place or not). For example, if security is not established, the device may include a random number.

In one solution, whether the device includes a device ID or a random number may depend on any combination of factors used for determination of the random access type, as described in details in subsequent paragraphs.

In one solution, the device may send a portion of the device ID in the first message, where the portion of the device ID that is sent is dependent on the allowed transmission duration of the message. If the number of bits of the device ID is larger than a threshold, the device may continue with a 2-step random access procedure. Otherwise, the first message is assumed to be the first message of the 4-step random access procedure.

Without limitation, the above solutions apply also to the 4-step random access procedure.

In another solution, a 4-step random access procedure may be performed by the device. In the 4-step random access procedure, the device may transmit two messages to gain access to an occasion, or to be able to perform any subsequent transmissions without additional contention.

In the 4-step random access procedure, the reader may send a paging message that may include one or more of: a single device ID, a list of device IDs, a group ID indicating a group (or subgroup) of WTRUs, or set of group IDs. In one example, the group or subgroup may be associated with the devices whose device IDs have common bits with the sent single device ID or with the sent list of device IDs. In one example, the group or subgroup may have been established previously, e.g., using previous messages or configuration by the reader.

The paging message may include an indication that any device should respond to the paging (e.g., no device ID or group ID is included in the paging message).

The reader may send a “query-like” message, the message may contain a configuration of the resources for the random access, such as the number of access occasions, and the frequency, timeslot, symbol resources, possibly associated with each access occasion; an indication of the data being requested by the reader (e.g., requesting an application layer ID, or requesting application layer data).

The paging message and the query-like message may be different messages. They may be sent separately in 2 distinct transmissions. They may be concatenated and sent in a single physical transmission. The information of the two messages may be combined and sent all together in one message, e.g., send a query-like message with paging information added to it, or send a paging message with the configuration that would otherwise be included in the query-like message.

A device, upon receiving the reader message(s), may select resources (e.g., access occasion, frequency, time slot, symbol resources) in which to transmit a first message.

The start of the resources (e.g., the access occasion) may be indicated by a message transmitted by the reader. This message may contain further information about the resources (e.g., symbol, timeslot, and/or frequency resources) associated with the access occasion. This message may contain further information about the random access associated with the access occasion, such as the random access types (e.g., 2-step, 4-step, etc.) allowed in the access occasion.

The device may transmit, upon receiving the message from the reader, and in the selected resource, a first message. The device may select a resource (e.g., access occasion, frequency, time slot, symbol resources) in which to transmit the first message.

The first message from the device may contain a random number. The random number may be of a fixed size (number of bits). The random number size (number of bits) may be configured by the reader in one of the previous transmissions by the reader. The random number size may be determined by the device based on any of the factors described for determining the random access type.

The first message from the device may contain a device ID. The device ID may be a permanent ID assigned to the device. The device ID may be an upper layer (e.g., application layer) device ID, possibly assigned by the application communicating with the device. The device ID may be an AS layer device ID assigned by the reader. The device ID contained in the message may be a portion of any of the aforementioned device IDs, such as the MSB (most significant bits) or LSB (least significant bits), or a combination thereof. The device may be configured with a predefined number of bits of the device ID to send. The device may send as many bits of the device ID as it is able to transmit given some transmission constraints, e.g., constraints on the device's available energy, or constraints on the allowed transmission duration.

The reader, upon receiving the first message, may respond with a second message. The second message may contain the same random number received in the first message. The second message may contain the same device ID received in the first message. The second message may include a newly assigned device ID which is being assigned to the device and it may be used in subsequent procedures. The second message may include a subsequent resource for sending a response to any subsequent commands the reader may send to the device.

The device, upon receiving the second message, may determine whether to transmit a third message. The determination may be based on successfully matching the transmitted element (e.g., device ID, random number, or another element) in the first message with the received element in the second message.

The device may determine to send a third message. The third message may include a device ID. The device ID may be a permanent device ID (statically assigned to the device). The device ID may be an upper layer device ID assigned by the application communicating with the device. The device ID may be an AS layer device ID assigned by the reader.

The device ID may be a portion of a device ID. For example, the device may send a predefined number of bits of a device ID. For example, the device may send as many bits of the device ID as it can transmit with the available energy or with the allowed transmission duration

The third message may contain a data element, may contain a data element. A data element (or portion of a data element) may be provided by upper layers or application layer in response to information received in a previous message from the reader. The portion of the data element may be limited by the same factors as the device ID. The data element may contain, e.g., sensor data, list of events, or data associated with a memory location.

The device ID may be considered as a data element. For example, there may be 2 device IDs, one at the application layer and one at the radio layer. The application layer device ID may be (part of) the data element. Or, the permanent device ID may be (part of) the data element.

For example, the portion of the device ID not included in the device ID “field”, may be added to a data element, when permissible (i.e., other data does not use all the available data element bits.

Upon reception of the third message, the reader may send a fourth message. The fourth message may include the newly assigned device ID (assigned in the second message from the reader, or it may have been omitted from the second message from the reader). The fourth message may include the device ID, included by the device in the third message, or a portion thereof. The fourth message may include an indication to use the random number as the device ID. The fourth message may include a command or a request from the reader.

Upon reception of the fourth message, the device may perform an additional contention resolution step which may consist of comparing an element received in the fourth message with an element transmitted in the third message. If the elements match, the access procedure is successful.

After successful access, any subsequent data messages transmitted by the reader to the device may not require the device ID. The device may respond to subsequent messages (commands) received from the reader without performing any random access procedure. For example, the device may continue to transmit in the same access occasion, possibly in the same resources (frequency, timeslot, symbols). The device may continue to transmit data to the reader as long as it has additional data associated with a request that was received from the reader. The device may transmit until the access occasion ends. The device may also continue to receive requests from the reader, and respond accordingly.

Subsequent messages transmitted by the reader, after this point, may be sent directly to the device and without the inclusion of the device ID in the message.

As previously stated, the 2-step and the 4-step random access may be considered contention-based random access. As described above, the device may determine whether a contention was successfully resolved based on e.g., parameters echoed by the reader.

In a contention-free random access the reader may send a paging message with device identification, as it was described in the 2-step and 4-step procedures described in above paragraphs.

The reader may send a query-like message including a configuration of the resources for the random access. The configuration may include the number of access occasions, the channel resources such as the frequency, timeslot, symbol, possibly associated with each access occasion. The query-like message may include an indication of the data being requested by the reader (e.g., a request for an application layer ID, or a request for application layer data).

The paging message and the query-like message may be sent in a single physical message or concatenated messages in the same transmission.

A device which receives the reader message(s) may select a resource (e.g., access occasion, frequency, timeslot, symbol) in which to transmit a first message. The selection of the resources may be based on several aspects, and solutions for access resource selection are discussed in later paragraphs.

The device may transmit a data requested in the selected resource. Upon reception of the data element, the reader may send an acknowledgement, or another command to the device.

Methods, for a device or a WTRU reader, to determine which access type may be used in a specific access attempt are described.

A device (e.g., AIoT WTRU, TAG) may determine the random access type.

In one family of solutions, a device may determine the random access type on its own, based on certain conditions, possibly where such conditions are determined upon triggering of the random access.

Example of factors influencing the device determination of the type of random access procedure to perform, include: content stored in the device (e.g., device ID); what triggered the random access, including the contents of the message that triggered the random access, such as content of the paging message; availability of random access resources; information associated with the specific resource selected to perform the random access; transmission characteristics such as transmit power, preamble information, coding and modulation scheme; information to be transmitted after the random access, such as control or data, QoS of the data, data size; the device type; history of previous random access attempts, such as number of attempts, time since last successful attempt; stored energy; measurement results; location or distance from reader; data transmission duration allowed or required; reader information such as reader identity or reader transmission characteristics; security requirements.

The determination may be based on any one of the conditions or a combination of the conditions. Combinations at different levels are also possible, for example, having both or either condition associated with two different factors, using a first factor to decide when a second factor is satisfied, otherwise using a third factor to decide, or determining a threshold or condition for a first factor using a second factor, or any other combination of factors at multiple different levels of “if, or, and, then”.

In one embodiment, a device may determine the type of random access to perform based on presence of a specific context in storage or the characteristics of a stored context (or of an element of the stored context) at the device.

A device may determine the type of random access to perform based on whether the device was previously assigned an identity, possibly by the reader. For instance, the device may initiate a first random access type if it has a stored identity (e.g., AS layer ID) previously assigned by the reader and may initiate a second random access type if it does not have a stored AS layer ID assigned by the reader. For example, a device with a stored ID may not need an access procedure with contention resolution.

A device may determine the type of random access to perform based on the characteristics of the stored context (or of an element of the stored context) at the device at the time the random access is triggered. For instance, the device may initiate a first random access type or a second random access type based on the length of the identity stored at the device. The length of the stored identity may provide an indication of whether that identity is unique between UEs, and whether contention resolution is needed. For example, if the identity is of a first length, it initiates a first random access type, and if the identity is of a second length, it initiates a second random access type.

In another embodiment, a device may determine the type of random access to perform based on contents of the message that triggers the random access, or another message sent by the reader (e.g., possibly configuring the random access procedure).

A device may determine the type of random access to perform based on an explicit indication. The messages from the reader which triggers the random access may contain an explicit indication of whether to perform one type of random access or another type of random access. The message may contain an IE which identifies the random access type.

In one example, the message type received from the reader may initiate a different type of random access. For example, upon reception of a first control element (e.g., one MAC CE or RRC message) the device may initiate a first type of random access and upon reception of a second control element (e.g., another MAC CE or RRC message) the device may initiate a second type of random access.

In another example, the device may determine the type of random access based on whether the message includes or does not include a specific element or IE (e.g., a MAC CE, or an RRC message). For example, if the message from the reader includes a contention resolution configuration, the device may use the random access type associated with that configuration.

In another example, the device may determine the type of random access based on configuration information sent by the reader and associated with the procedure, or an occasion associated with the random access.

A device may determine the type of random access to perform based on an upper layer procedure (application layer procedure) initiated in the device by the message or another message.

In one example, the paging message or another message sent before or after the paging message, may initiate one or more different procedures at the device, such as an inventory procedure (i.e., the device provides its device ID to indicate its presence), a write command (i.e., the device receives data or application control that needs to be written to memory), a read command (i.e., the device receives a request to transmit a specific element of stored or measured data), an enable/disable command (i.e., the device is changed from active to inactive or vice versa), or a keep-alive or tracking command (i.e., the device responds with an indication of its ability to receive messages). The paging message, or another message received from the reader which may arrive before or after the paging message, may contain an explicit indication of the upper layer procedure. Alternatively, the message may contain information, be sent using a specific mechanism (e.g., a specific layer, contain a specific header, or a control element) which may implicitly indicate the upper layer procedure. A device may determine the random access type based on the upper layer procedure. For example, a random access type may be exclusively used with one or more upper layer procedures.

A device may determine the type of random access to perform based on the identity or group of identities received in the message that triggers the random access (e.g., the paging message).

In one example, the random access may be triggered by reception of a paging message which contains one or more IDs, where the one or more IDs refer to one or more WTRUs, a group of WTRUs, or identify all WTRUs. Such may be a single ID as well as a mask or qualifier, whereby the ID and qualifier identifies a group of WTRUs. Such ID may be multiple IDs where each ID identifies uniquely a single WTRU or a group of WTRUs.

In another example, the device may determine the type of random access to perform based on the type of identity included in the paging message, or the type of identity the device associates itself with. For instance, the device may initiate a random access procedure if the WTRU's ID matches an ID or an ID group indicated in the paging message. If the matching ID is of a first type, the WTRU may initiate a first type of random access, while if it is of a second type, the WTRU may initiate a second random access. In one example, if the ID is a permanent ID, the device may perform a first type of random access, while if the ID is an ID previously assigned by the intermediate WTRU, the device may perform a second type of random access. The ID types may comprise an upper layer ID (e.g., NAS), an AS layer ID (e.g., assigned by the RAN), a static device ID (e.g., pre-provisioned or hardcoded into the device).

In another example, the device may determine the type of random access to perform based the size of the group of devices indicated by the paging message. For instance, the device may determine the random access type based on the number of devices (or the size of the group) being paged or expected to initiate the random access procedure. For example, if the number of devices is below a threshold, the device may initiate a first random access type, otherwise it may initiate a second random access type. For example, the size of the group may be used in conjunction with another factor (e.g., the number of resources) to determine the random access type. For example, if the number of devices divided by the number of resources is larger than a threshold, the device may initiate a first random access type rather than a second random access type. This is motivated by the fact that random access by a larger group of devices may increase the probability of contention, and may benefit from an additional step of contention resolution in the procedure.

A device may determine the type of random access to perform based on the format of the identity, as carried in the paging message. For instance, the devices or group of devices are identified in the paging message. The identity may consist of a group ID, or an ID along with a mask (e.g., where the mask may identify the specific bits of the WTRU ID which should be considered to identify the group of WTRUs). For example, if the device receives a mask as part of the identification, it may initiate a first type of random access, while if it does not, it may initiate a second type of random access. The device may receive (e.g., in the paging message) either a group identity (i.e., indication of a range of device IDs) or a list of device IDs. If the device receives a list of device IDs, it may initiate a first type of random access while if it receives a group identity, it may initiate a second type of random access.

A device may determine the type of random access to perform based on the size of the identity. The length of the identity may provide an indication of whether that identity is unique between WTRUs, and whether contention resolution is needed. For instance, the device may be configured with a threshold in terms of number of bits of the device ID in the paging message. For instance, if the number of bits is larger than a threshold, the device may use a first random access type, otherwise, it may use a second random access type.

In one example, the device may belong to more than one groups or classes of devices. The device may determine the type of random access to perform based on the specific group or class of devices that is currently being referenced in the paging message. For instance, whether the paging message refers to a specific set of devices, based on possible nature of the devices or context associated with the devices.

For instance, if the paging message requests access only by devices which have a stored AS layer ID or context, the device may initiate a first type of random access, otherwise, it may initiate a second type of random access.

For instance, if the paging message requests access by any/all devices that are able to receive the paging message, the device may initiate a first type of random access procedure, otherwise, it may initiate a second type of random access procedure.

For instance, if the paging message requests access by devices of type 1 only (i.e., backscattering devices only) the device may initiate random access of a first type, otherwise, it may initiate random access of a second type

In another embodiment, a device may determine the type of random access to perform based on the available resources (e.g., time, frequency, or occasion) that can be used for random access procedure, or is signaled by the reader.

The device may determine the type of random access to perform based on the number of access occasions configured/signaled by the reader. The device may determine whether to use a first type or second type of random access procedure based on the number of access occasions configured by the reader, possibly for an access round. For example, if the number of access occasions is larger than a threshold, the device may select a first random access type, otherwise, it may select a second random access type. For example, if the number of access occasions divided by the number of devices being paged is larger than a threshold, the device may select a first random access type, otherwise it may select a second random access type. For example, if the reader signals a number of access occasions, the device may initiate a first random access type, otherwise (no signaling of the access occasions), the device may initiate a second random access type. In one example, the case where no access occasions are signalled may indicate to a contention-free type may be used, where only a single device accesses each predefined occasion.

The device may determine the type of random access to perform based on the number of access occasions that can be selected by the device. The device may be limited to selection of a subset of the configured occasions. For example, some occasions may be configured (by the reader) or determined (by the device) as unusable based on device capability, available energy, presence of a backscattering signal, etc. The device may then select from a number of remaining access occasions. If the remaining number of access occasions is below a threshold, the device may initiate a first type of random access procedure, otherwise, it may initiate a second type of random access procedure. In one example, if access attempts are delayed due to, e.g., low power and charging scenarios, some access occasions at the beginning may not present high usage, which may yield in larger contention during the last access occasions.

The device may determine the type of random access to perform based on the number of access occasions or resources (e.g., frequency resources, timeslots, symbols) available for transmission. A larger number of resources may be associated with less likelihood of contention and with the increase the available bandwidth to carry data.

For example, if the number of time/frequency resources available for transmission of the first message is above a threshold, the device may select a first random access type, otherwise, it may select a second random access type. For example, if the number of devices signaled in the paging message is less than or equal to the number of resources, the device may initiate a first type of random access procedure, otherwise, it may initiate a second type of random access procedure.

In another embodiment, a device may determine the type of random access to perform based on the specific resource (e.g., time, frequency, occasion) associated or selected by the device for transmission, and possibly information provided by the reader.

The device may determine the type of random access to perform based on a specific inventory occasion. For example, the device may receive a configuration of the occasions associated with a specific type of random access in the paging message, or other message sent by the reader which may initiate the access.

The device may receive a specific configuration associated with the occasion in which random access should be started. The device may receive a configuration message (e.g., an RRC message or a MAC CE) which contains a mapping of the random access type to perform for each occasion. The device, upon determination that it should initiate random access on the Nth occasion of an inventory procedure, may perform the random access type that is associated with the Nth occasion in the configuration message

For example, the device may receive the random access type to be applied in a specific occasion in the message sent by the reader that initiates that specific occasion (i.e., the occasion sync message, or query message).

The device may receive a number of occasions (or a subset of the occasions) which are associated with a first type of random access, possibly from the reader. For example, the first X occasions of the set of N occasions may be associated with the first type of random access, while the remainder are associated with the second type of random access. The device may receive the value of X from the reader (e.g., in a control message). When the device determines the occasion for the random access, it may initiate the random access of the type associated with that occasion.

For example, if a device satisfies other conditions associated with performing a specific type of random access procedure, it may select among all the access occasions, or may select the access occasions only associated with that type of random access procedure.

A device may determine the type of random access to perform based on a specific frequency resource used. The device may be configured with specific frequency resources which are associated or dedicated for one type of random access or another. When the device determines the frequency resource for transmission or one or more messages associated with the random access, it may use the random access type associated or configured for that resource.

A device may determine the type of random access to perform based on a slot-based (synchronized) or non-slot based (non-synchronized) transmission. For example, the device may determine the random access type based on the timing of the transmission with respect to reader transmissions. The device may determine the random access type depending on whether the transmission performed by the device during random access is performed in a time occasion which is entirely determined by a downlink transmission by the reader, or whether the device transmission is performed based on timing maintained at the device (e.g., a slot, a predefined time value after a slot, or a predefined time value following downlink transmission by the reader).

For example, the device may use a first random access type if it can consider its transmissions to be slot synchronized, while it may use a second random access type if it cannot consider its transmission to be slot synchronized.

In another embodiment, a device may determine the type of random access to perform based on characteristics of the signal or transmission associated with the device's transmission and/or requested by the paging message itself (or another message). For instance, the paging message and/or other message which configures or initiates the random access may request transmission with a specific signal or transmission characteristics. Alternatively, the device may determine or be configured to use a specific signal or transmission characteristics. This is motivated by the fact that some types of signals may have specific characteristics that are beneficial to the receiver in cases of contention, e.g., improving the decoding of the signals when a collision occurs. The device may determine the random access type based on the requested or determined signal or transmission characteristic.

A device may determine the type of random access to perform based on the multiple access type. Device transmissions may use any or a combination of TDMA, FDMA or CDMA. The device may use a first random access type if the transmission is associated with a first multiple access type, and may use a second access type if the transmission is associated with a second multiple access type.

Different types of access may have different power requirements. A device may determine the type of random access to perform based on the transmit power requirement. The device may determine the random access type based on the transmit power associated with one or more of the transmissions associated with the random access procedure. For example, if the transmit power is above a threshold, the device may select a first random access type, otherwise, it may select a second random access type.

A device may determine the type of random access to perform based on the source of energy used for transmission. The device may determine the random access type based on the source of energy used for transmission. The device may perform transmission based on stored energy (e.g., from energy harvesting). Alternatively, the device may perform transmission based on backscattering of a carrier signal received from an external device or power source. Alternatively, a device may use its own device power (e.g. a battery). For example, the device may determine the random access type based on the source of energy used to perform transmission of one or more messages during the random access procedure.

A device may determine the type of random access to perform based on the modulation and coding. The device may determine the random access type based on the coding of any of the messages. For example, if the device uses a first MCS, it may initiate a first random access type, while if it uses a second MCS, it may initiate a second random access type. For example, the device may initiate a first random access type if the MCS is at least a specific level, otherwise, it may initiate a second random access type.

A device may determine the type of random access to perform based on presence and/or characteristics of a preamble and/or midamble and/or postamble. E.g., the device may determine the random access type based on whether or not any of its transmissions contains a preamble (and/or midamble and/or postamble), or the length of such preamble (and/or midamble and/or postamble). For example, transmissions including a midamble may be associated with a larger message size, which may require one type of random access over another.

In another embodiment, a device may determine the type of random access to perform based on the characteristics of the data/information to be transmitted by the device.

A device may determine the type of random access to perform based on the QoS characteristics of the data (to be transmitted after the random access). For example, if the priority, latency, or other QoS characteristic of the data or information to be transmitted by the device meets a specific condition, the device may initiate a first random access type, otherwise, it may initiate a second random access type.

A device may determine the type of random access to perform based on control or data transmission. For example, the device may select a first random access type for control transmission and a second random access type for data transmission. For example, if the device transmits an acknowledgement to a command, the device may select a first random access type, otherwise, it may select a second random access type.

A device may determine the type of random access to perform based on the size of the data payload. For example, the device may be configured (e.g., by the reader) with a threshold payload size for transmission of a message with the random access procedure. Specifically, if the data payload size is below a threshold, the device may transmit the data using a first random access type, otherwise, it may transmit the data using a second random access type.

In another embodiment, a device may determine the type of random access to perform based on the device type. A device may have different rules, thresholds, or conditions for selecting between different random access types based on the device type or device capabilities. For example, devices of a first type or with a first set of capabilities may select between a first and second random access type based on a first set of conditions on modulation and coding. Devices of a second type or with a second set of capabilities may select between a first and second random access type based on a second set of conditions on modulation and coding. For example, different access types may require different power ramp-up processes. Some power ramp-cesses may be very aggressive. For instance, some access types may require a large power variation in a very short period of time, some may start at a very high power level. A device that may have power boosting constraints may require more relaxed conditions and, accordingly, select a different type of access.

In another embodiment, a device may determine the type of random access to perform based on previous success of the random access procedure. For example, the device may perform one type of access procedure which does not require much power. If this type of access results in failures, the device may opt for a more robust type of access, even though it may require more power. The device may attempt one random access type a number of times, and if they are unsuccessful, they may fallback to a more robust type of random access. For example, the device may determine the type of random access to perform based on the number of attempts. For instance, the device may attempt a first type of random access, possibly a configured number of times. If random access is not successful, the device may attempt a second random access type. In order to limit the number of attempts, the device may history to learn, e.g., some specific hours of the day may be considered “busy hours,” and the device may learn to use the more robust access type during those hours.

A device may determine the type of random access to perform based on the time since last successful attempt. For example, the device may attempt a first random access type. If random access is not successful, it may attempt a second random access type if it needs to perform random access during a period of time (e.g., actual time, number of occasions, or number of inventory procedures) immediately following the failed random access. Following that period of time, the device may re-use the first random access type.

A device may determine the type of random access to perform based on the number of messages received or transmitted since last successful attempt. For example, the device may attempt a first random access type. If random access using the first type is not successful, the device may attempt a second random access type for each access until a number of messages have been received (from the reader) or transmitted (by the device), after which, the device may re-use the first random access type.

A device may determine the type of random access to perform based on whether a specific message is received or transmitted since the last successful attempt. For example, the device may attempt a first random access type. If random access using the first type is not successful, the device may use a second random access type until a specific message (e.g., a control message) is received (from the reader) or transmitted (by the device, possibly following a request from the reader). The device may then go back to using the first random access type whenever it performs random access.

In another embodiment, a device may determine the type of random access to perform based on stored energy at the device. For example, if the amount of stored energy at the device is larger than a threshold, the device may perform a first random access type, otherwise, it may perform a second random access type.

For example, if the device has sufficient stored energy to transmit for a period of time which is larger than a threshold, it may perform a first random access type, otherwise, it may perform a second random access type. For example, if the device does not or cannot store energy, it may always use a first random access type.

In another embodiment, a device may determine the type of random access to perform based on measurements at the device. For example, if the measured RSRP is below a threshold, the device may use a first random access type, otherwise, it may use a second random access type.

In another embodiment, a device may determine the type of random access to perform based on location/proximity indications sent by the reader. For example, the device may receive (e.g., in a control message, or a MAC CE included with the paging message) an indication of the distance between the reader and the device. The device may select between a first or a second random access type based on this distance indication and possibly other factors (e.g., device type, transmit power, payload size). For example, for a given distance indication, the maximum payload size for use of a first random access type may be a first value, while for a second distance indication, the maximum payload size for use of a second random access type may be a second value. For example, a device may receive an indication that the distance is unknown, or that the reader has moved. In such case, the device may always use a first random access type.

In another embodiment, a device may determine the type of random access to perform based on transmission duration. For example, a device may be (pre) configured with a maximum transmission duration. The device may further determine the required transmission duration for a message associated with a first type of random access procedure based on factors such as, available energy, required modulation and coding scheme (MCS), device capabilities, indicated proximity, etc. If transmission using a first random access type exceeds a maximum transmission duration, the device may select a second random access type. For example, the device may split the data (e.g., a device ID) into two parts and send it with separate messages as part of the second random access type when sending it with a single message (e.g., using a first random access type) results in exceeding the maximum transmission duration. For example, the maximum transmission duration may consist of a slot or a (pre) configured number of slots.

In another embodiment, a device may determine the type of random access to perform based on the reader (or some identity of the reader). For example, based on some transmission characteristics of the reader, the device may decide to perform a first random access type for a reader with a first characteristic, and a second random access type otherwise. For example, the reader may transmit a reader identification in any of the reader transmissions above. if the device has not accessed the reader in the past (e.g., based on the ID) or if the last reader access by the device is different than the current reader initiating the random access, or the device has not accessed a reader transmitting the same ID in the past or in the previous access, the device may trigger a first random access type, otherwise, it may trigger a second random access type.

In another embodiment, a device may determine the type of random access to perform based on security establishment and/or some upper layer messaging status. For example, if security has yet to be established, the device may trigger a first random access type, while if security has been established already, the device may trigger a second random access type. For example, if an upper layer connection or an upper messaging exchange (e.g., NAS) has yet to be established, the device may initiate a first random access type, otherwise, the device may establish a second random access type.

As previously mentioned, combinations of several factors and at different levels may be possible.

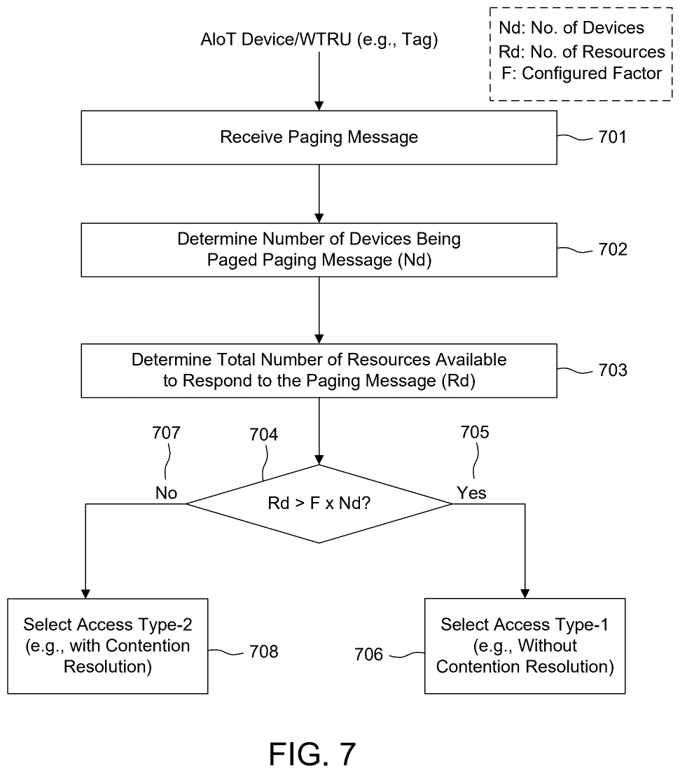

FIG. 7 illustrates a flow chart of an example of a process for selecting an access type to use based on two factors: number of devices being paged and total available access resources.

A device may receive a paging message 701. The device may determine the number of devices being paged in the received paging message 702, referred to as Nd. The device may determine the total number of access resource available to the devices for responding to the paging message 703, e.g., access opportunities, referred to as Rd. The device may verify if the number of access resources is larger than a factor F of the number of devices in the paging message, Rd>F×Nd 704, where F is the factor parameter previously configured in the device. If it is 705, the device may select an access type that does not require contention resolution, e.g., access type 1 706. Otherwise 707, it may select an access type that requires contention resolution, e.g., access type 2 708.

If a device selects a specific access type and the procedure fails, the device may reselect the access type for future attempts, e.g., the device may maintain a history on the number of failed attempts.

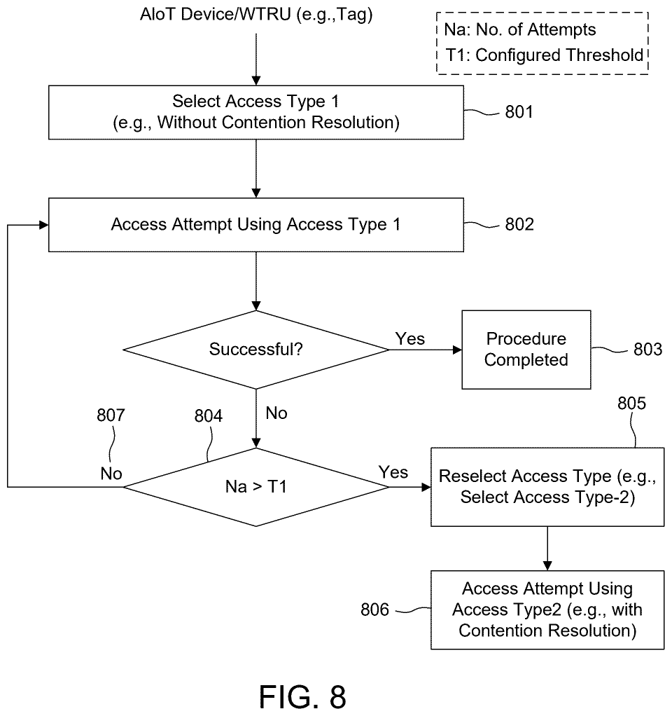

FIG. 8 illustrates a flow chart of an example of a process for an access type reselection.

Referring to FIG. 7, the device may verify that Rd>Factor×Nd 705 and initially select access type 1 801. The device may then perform the access attempt using access type 1 802. If the attempt is successful, the procedure is completed 803. If the attempt fails, the device may determine if the number of failures of consecutive attempts using access type 1, Na, is greater than a configured threshold for access type 1, T1 804. If Na>T1, the device may select another access type for the next attempt, e.g., access type 2 805. The device may continue using access type 2 until the procedure is successful 806. If Na≤T1 807, the device may remain using access type 1, until it either succeeds 803 or it reaches the threshold T1, in which case it may reselect the access type 805.

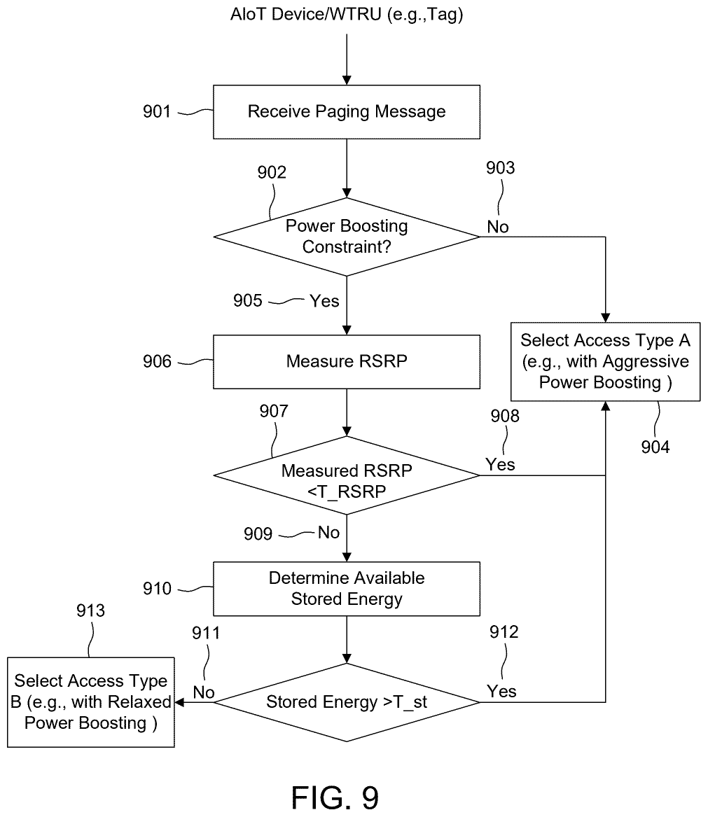

FIG. 9 illustrates a flow chart of an example of a process for selecting an access type to use base on a combination of factors at different levels.

In the example in illustrated in FIG. 9, there may be two types of access procedures, and one of them, e.g., access type A, may require a more aggressive power boosting process than the other type, access type B. Upon receiving a paging message 901, The device may determine if it is currently under power boosting constraints 902. This determination may be based, e.g., on the current stored energy amount, or the currently recharging conditions, such as whether or not the device has access to power source and is currently charging. If the device is not currently under power boosting constraints 903, it may select the access type with aggressive power boosting requirements, e.g., access type A 904.

If the device is currently under power boosting constraints 905, it may measure the RSRP 906 and verify if the measured RSRP is above or below a configured threshold, T_RSRP 907. Even though the device is under a power boosting constraint, the signal strength is be so low, a less aggressive power boosting process may just waste the available energy and fail nonetheless. In this case, even though access type A requires a more aggressive power boosting process, the device may have no choice but to select that type of access to have a chance to succeed, justifying the spending on the power boosting. Accordingly, if measured RSRP<T_RSRP 908, the device may select access type A 904.

If the measured RSRP≥T_RSRP 909, the device may determine its available stored energy 910 and compare it with a configured threshold, T_st 911. If the stored energy is greater than the threshold T_st 912, the device may select the access type with the more aggressive power boosting process, e.g., access type A 904. Otherwise, the device may select access type B, with the more relaxed power boosting process. As the signal strength is good (measured RSRP≥T_RSRP), a more relaxed approach may still yield in a successful attempt and help with power savings.

The examples illustrated in FIGS. 7 to 9 are non-limiting examples. For instance, the examples include only two access types for the device to select from. However, a plurality of access types may be available, and similar methods may be applied for the selection of an access type from the plurality of access types. The examples utilize only a sub-set of a large set of possible factors the device may consider and illustrate a number of possible combinations of the different factors that may be used during the access type selection. The solutions described apply to the many other factors, such as all the ones discussed in previous paragraphs, and also other similar aspects that may not have been listed herein, but are similar in nature to the ones provided. In addition, a number of combination of factors may be applied to the selection without impacting the methods and solutions. As an example, referring to the solution illustrated in FIG. 9, after the initial access type selection, the device may continue further evaluation of internal and external conditions, and it may trigger an access type reselection. The reselection may be based on the number of failed attempts, as it was described for the example in FIG. 8. The reselection may be based on updates on the internal device conditions, including, for example, the available energy stored or the current charging conditions. As such, many other combinations are possible.

In the solutions described in previous paragraphs, the device may select the access type. However, there may be occasions that a reader or an intermediate WTRU may have more information available to make the selection on behalf of the device, or to guide the device by providing additional information or direction and guidelines.

A WTRU (e.g., intermediate WTRU, reader, interrogator) may determine the random access type to be used by one or more devices.

In one family of solutions, a WTRU may determine the random access type to be applied by a device, possibly in a specific resource (e.g., an access occasion, a time slot, or a frequency resource). The WTRU may indicate the random access type to be performed, possibly in the specific resource, in a message to the reader (e.g., the paging message, a or MAC CE within the paging message, an RRC message). Such may be any message from the reader to the device, possibly associated with a set of resources, possibly indicating the random access type to be applied to a specific resource.

A WTRU may signal the random access type for all resources (e.g., all occasions) in a single message. For example, the WTRU may send a paging message, a query message, a configuration message, or similar which indicates the number of occasions and possibly the random access type associated with each occasion (e.g., as a bitmap, or as an ordered list of occasion to type).

In another alternative, the WTRU may signal the random access type for a resource (e.g., an occasion) in the reader to device message (i.e., in a transmission made by the WTRU) which may initiate or define the start of that resource. For example, the WTRU may send the random access type for an occasion in a query rep message or similar message that initiates the start of that access occasion.

A WTRU may determine the random access type to be indicated to a device based on one or a combination of the same factors which the device may use to perform such determination.

Additionally, the WTRU may determine the random access type to be indicate to a device based on one or a combination of the following factors.

In one embodiment, a WTRU may determine the random access type to be indicate to a device based on the expected message size to be transmitted by one or more of the devices. The WTRU may receive a command, message, or trigger from the network that initiates one or multiple requests to be transmitted to the devices on the AIoT interface.

In one example, the WTRU may receive an expected message size (e.g., in an RRC message) from the network, possibly along with the command, message, or trigger (e.g., an inventory).

In another example, the WTRU may receive a command type, and may be (pre)configured with a mapping between message size and command type

In another example, the WTRU may receive an application layer command, and may map the application layer command to an expected message size.

A WTRU may determine the random access type associated with one access occasion, a number of access occasions, or all access occasions based on the message size expected from the device transmissions in that (those) access occasions. Specifically, if the expected message size is larger than a threshold, the WTRU may indicate that occasion to be of a first type of random access procedure.

In another embodiment, a WTRU may determine the random access type to be indicate to a device based on a characteristic of the access occasions or access resources.

In one example, the WTRU may determine the random access type to be indicate to a device based on the number of resources or access occasions. For example, if the number of access occasions (e.g., configured by the network, or determined by the WTRU) is above a threshold, the WTRU may determine the random access type to be of a first type (possibly for all the access occasions), otherwise, it may determine the random access type to be of a second type.

In another example, the WTRU may determine the random access type to be indicate to a device based on the time and/or frequency resources or the duration of each access occasion. For example, if the duration of an access occasion (e.g., configured by the network, or determined by the WTRU) is above a threshold, the WTRU may determine the random access type to be of a first type for that access occasion, otherwise, it may determine the random access type to be of a second type for that access occasion.

In another embodiment, a WTRU may determine the random access type to be indicate to a device based on a characteristic of the devices being inventoried (as per request from the network, or as determined by the WTRU).

In one example, the WTRU may determine the random access type to be indicate to a device based on the number of devices. The WTRU may receive a list of device IDs, a range of device IDs, or similar from the network (e.g., in an RRC message). The WTRU may indicate this list of devices in the paging message, or similar message, sent to the devices. For example, if the number of devices is above a threshold, the WTRU may determine the random access type to be of a second type, otherwise, it may determine the random access type to be of a first type. For example, if the ratio of the number of device IDs to the number of access occasions is above a threshold, the WTRU may determine the random access type to be of a first type, otherwise, it may determine the random access type to be of a second type.

In another example, the WTRU may determine the random access type to be indicate to a device based on the number of devices known to the WTRU, having context at the WTRU, or having responded to the WTRU in a previous access request (e.g., paging message including those devices in the device ID). The WTRU may receive a list of device IDs, a range of device IDs, or similar from the network (e.g., in an RRC message). The WTRU may determine which of these devices IDs corresponds to devices which have already responded to a request (e.g., paging) on the AIoT interface, possibly in the last x seconds. The WTRU may maintain the context for these devices. For example, the WTRU may assign a second (e.g., AS layer) device ID to these devices. For example, the WTRU may page these devices using the second (e.g., AS layer) device ID, rather than the device ID received from the network. For example, if the number of devices, from those received from the network, which have already responded to the WTRU is larger than a threshold, the WTRU may determine the random access type to be of a first type, otherwise, it may determine the random access type to be of a second type. For example, if the ratio of the devices that have already responded to the devices received from the network (or to be sent in the paging/request) is larger than a threshold, the WTRU may determine the random access type to be of a first type, otherwise, it may determine the random access type to be of a second type.

In another example, the WTRU may determine the random access type to be indicate to a device based on a device's location, or knowledge of its location. The WTRU may determine, estimate, or receive the location of a device, or a distance between the WTRU and the device. Distance may be determined, e.g., in terms of a distance measure, or a measure of the path loss.

For instance, if the WTRU sends a request or paging message to a device whose distance is below a threshold, the WTRU may determine to use a first random access type for the access occasion associated with that device, otherwise, it may determine to use a second random access type for the access occasion associated with that device.

For instance, if the WTRU changes its location since the last time it received a message from the device, possibly by more than a threshold distance, the WTRU may determine to use a second access type for the access occasion associated with that device.

In another example, the WTRU may determine the random access type to be indicate to a device based on a device's device type or capabilities. The WTRU may receive a device's device type or capabilities from transmissions performed by the device (e.g., in a control message, a MAC CE, or a protocol layer control packet data unit (PDU)). For example, the WTRU may determine the random access type for the occasion associated with that device based on the device type or capabilities.

In another example, the WTRU may determine the random access type to be indicate to a device based on a device's last successful random access type.

For instance, if a device last performed random access successfully using a first random access type, the WTRU may determine the random access type for a subsequent access by the device to be of a first random access type. For example, if a device last performed random access successfully using a second random access type, after trying unsuccessfully using a first random access type, the WTRU may determine the random access type for the device to be a second random access type. For example, if the device last performed random access successfully using a second random access type, and a first random access type was not attempted in the past (possibly over a specific period of time), the device may determine the random access type to be either a first random access type or a second random access type.

For instance, if the device last performed data transmission a period of time ago which is larger than a threshold, the WTRU may determine a random access type for the device, otherwise, it may determine a second random access type.

In another embodiment, a WTRU may determine the random access type to be indicate to a device based on the nature or type of the request being performed by the WTRU and/or triggered by the network.

For example, the WTRU may determine the random access type to be signaled to the device based on the command or command type received from the network (e.g., in an RRC message). For example, this may correspond to the application layer or NAS layer operation to be performed to the device (e.g., inventory or command). For example, if the request is being sent by the WTRU as part of a read or write command, the WTRU may determine the random access type to be a first type. For example, if the request is being sent by the WTRU as part of an inventory of all devices, possibly within a range of device IDs (e.g., received by the network, or maintained by the device itself), the WTRU may determine the random access type to be a second type.

For example, the WTRU may determine the random access type to be signaled to the device based on the inventory is associated with failed devices only, or all signaled devices. For example, the WTRU may initiate a first procedure (e.g., inventory-like procedure) to trigger all devices to respond. Following the first procedure, the WTRU may trigger a second procedure (e.g., inventory-like procedure) which triggers only the devices which failed to access or send data during the first procedure to respond. The WTRU may further signal whether it is initiating a first procedure or a second procedure in the message to the devices (e.g., the paging message). For example, if the WTRU triggers a first procedure, it may determine a first random access type to be used, while if the WTRU triggers a second procedure, it may determine a second random access type to be used.

In another embodiment, a WTRU may determine the random access type to be signaled to the device based on a characteristic of the transmission to be performed by the WTRU. In one family of solutions, the WTRU may determine the random access type based on the characteristics of the transmission (e.g., paging message) which triggers the random access, such as, the transmit power, the transmit duration, or the MCS. The WTRU may further determine such characteristics from the network (e.g., based on RRC configuration, DCI signaling, or MAC CE).

A device (e.g., AIoT WTRU, TAG) may determine the access resources to be used in an access procedure.

The device may select a resource to initiate random access. Resource selection may comprise access occasion selection and/or time slot and/or frequency resource selection. A device may select an occasion for random access. The device may select a frequency resource in an occasion. The device may select a timeslot during an occasion. The device may select to perform transmission in an occasion without any consideration of a timeslot. The device may further limit transmission to one or more timeslots.

Methods, for a device or a WTRU reader, to determine the physical resources to be used in a specific access attempt are described.

A device (e.g., AIoT WTRU, TAG) may select the resource for random access initiation, continuation, or retransmission.

The device may select a resource based on one or a combination of the following factors.

A device may select a resource based on a random selection. For example, a device may select randomly from a set of occasions, resources, etc. that are allowable for transmission by that resource. The device may use other factors/criteria to determine whether a resource is allowable or not.

A device may select a resource based on the random access type. In one example, the device may be (pre) configured with a subset of resources associated with the random access type, and may only select from the resources allowed for that random access type. In another example, one random access type (e.g., contention based access) may allow selection based on one factor (e.g., random selection) while another random access type (e.g., contention free) may allow selection based on another factor (e.g., contents of the paging message).

A device may select a resource based on the available energy. In one example, the device may exclude resources where it may perform charging, or where it does not have sufficient energy for transmission. In another example, the device may select an occasion and/or a frequency resource that implicitly indicates its available energy to the reader

A device may select a resource based on the characteristics of the carrier wave or of the reader transmissions. In one example, the device may transmit on a resource or may select from a set of resources which is associated with the carrier wave frequency or transmit power, the reader frequency or transmit power, etc. In another example, the device may be allowed to use a subset of resources for each range of CW transmit power

A device may select a resource based on the paging message (or similar reader message that triggers the initiation of the random access) contents. In one example, the device may determine the resource for access based on its identity and/or the identities referenced in the paging message. For instance, in the case of contention free random access, the identities referenced in the paging message may represent an ordered list. The device may locate its own identity in the ordered list and select the Nth resource (e.g., occasion and/or frequency resource) based on the Nth identity in the paging message being identified as its own identity

In another example, the device may determine the resource for access based on an explicit indication in the paging message. For instance, the paging message may explicitly provide a resource or resource index to be used for each device being paged, for example, in the case of contention free random access

A device may select a resource based on messages from the reader during the random access procedure (e.g., MSG2, MSG4). In one example, the reader may provide the frequency resource for MSG3 transmission in MSG2 transmission. In another example, a retransmission resource selected by the device may consider the resources assigned by the reader for other devices. For example, if the device fails contention resolution and receives a message from the reader indicating the resources to be used by the devices that succeeded contention resolution, the device may exclude those resources in resource selection.

A device may select a resource based on the device's ID. As one example, the device may select from a different set of resources depending on whether it is configured or not with an ID. As another example, the device may select from a first set of resources for a first range of its ID, a second set of resources for a second range of IDs and so on.

A WTRU (e.g., intermediate WTRU, reader, interrogator) may determine the access resources to be used in an access procedure.

A WTRU may select the number of resources to be used for a random access procedure. For example, it may select the number of access occasions, frequency resources, and/or timeslots.

In one solution, a WTRU may select the number of resources based on the number of devices it expects to respond. For example, the WTRU may initiate a random access procedure with a set of known devices (previously accessed). For example, the WTRU may assign one or more dedicated resources for each device. For example, the number of access occasions may be defined such that each device has at least one access occasion to respond.

In another solution, a WTRU may select the number of resources based on the number of device IDs to be inventoried. For example, the WTRU may receive an inventory request from the network which contains a number of device IDs or a range of device IDs. The WTRU may be configured (e.g., in RRC configuration) with a number of resources to use for each ID range size. The WTRU may also be configured with a number of resources to use for an inventory of all devices in an area. The WTRU may perform such selection if it has such configuration. Otherwise, the WTRU may use other mechanisms to determine the number of resources.

In another solution, a WTRU may select the number of resources based on its transmit power. The WTRU may first select a transmit power (e.g., based on network configuration, based on WTRU implementation, etc.). Based on the transmit power, the WTRU may select an associated number of resources, for example, based on a configured mapping of transmit power (range) to number of resources.

In another solution, a WTRU may select the number of resources based on results of previous inventory procedures or random access procedures triggered by the WTRU. For example, if the number or ratio of resources without reception of an access by any device is above a threshold, the WTRU may reduce the number of resources for the next access by a configured amount. For example, if the number or ratio of resources where the WTRU detects access by a device is above a threshold, the WTRU may increase the number of resources for the next access by a configured amount.

In another solution, a WTRU may select the number of resources based on whether the random access is being triggered for initial attempts by the devices, or retried attempts for WTRUs that failed random access. For example, the WTRU may select a first number of resources for initial attempt. The WTRU may then select a second (e.g., smaller) number of resources for attempts only by WTRUs which were unable to access during the initial attempt.

In one solution, a WTRU may revert to a default, initial or configured number of resources upon a mobility procedure. For example, if the WTRU moves by more than a certain amount, if the WTRU performs RAU, TAU, reselection, or HO, the WTRU may revert to an initial number of resources, or reset any changes in the number of resources made from previous access before the mobility event.

As it is illustrated in FIGS. 7 to 9, and described in associated text above, there may be a set of factors and a number of combinations of such factors that may be used for an access type selection. As discussed, the selection may be done by the device, or by the WTRU (a reader WTRU or an intermediate WTRU) and then the result of the selection may be sent to the device, which will then perform the access using the selected access type.

In one example, A WTRU (a reader WTRU or an intermediate WTRU) may provide guidance to a device for the access type selection.

As previously discussed, there may be a set of factors that may be considered in a selection of an access type. The factors, say (f_1, f_2, . . . , f_n), may be associated with a combination of rules, say combinations (c_1, c_2, . . . , c_m). The set of factors and combinations may define the process, p, to be used for access type selection. For instance, p_1 may be a process that includes a combination of conditions (c_1), which may be applied and evaluated to factors f_1 and f_2.

As an example, referring to FIG. 8 for an access type reselection, the device may determine if the ‘number of failures of consecutive attempts using access type 1’, Na, is greater than a configured threshold for access type 1, T1 804. If Na>T1, the device may select another access type for the next attempt, e.g., reselect into access type 2 805. In this example, the factor being evaluated is the number of failures consecutive attempts using access type 1, Na, and the combination is a simple one: Na>T1. In this case, it is a combination of a single rule. This process, which includes this one factor and this one (combination) rule, may be referred to as process p_8 (as in FIG. 8).

As another example, referring to FIG. 9 for access type selection, initially, the device may determine if it is currently under power boosting constraints 902. In case the device is under power boosting constraints 905, it may measure the RSRP 906 and verify if the measured RSRP is above or below a configured threshold, T_RSRP 907. If measured RSRP<T_RSRP 908, the device may select access type A 904. In this example, the factors may the power boosting constraint state and the measured RSRP. The combination of rules may be power boosting constraint=Yes and measured RSRP<T_RSRP. This process, which includes two factors and the combination rule specified, may be referred to as process p_9 (as in FIG. 9).

Similarly, the process in FIG. 7 may be referred to as process p_7 (as in FIG. 7).

We may utilize these 3 possible processes, with their factors and combination of rules, as a basis for a non-limiting example: An AIoT system may be designed such that an access type selection is always performed according to the procedure illustrated in FIG. 7, e.g., the combination of factors, rules and conditions used during an access type selection may be the ones described in the text associated to FIG. 7. Process p_7. A different AIoT system may be designed such that the access type selection is always performed using a different combination of factors, rules and conditions, e.g., process p_8, as illustrated in FIG. 8 and associated text. A third AIoT system may be designed with third access type selection process, e.g., p_9, as illustrated in FIG. 9 and associated text. Accordingly, when the AIoT device is part of a system, it will follow the process specified for that system (e.g., p_7, p_8, or p_9).

An AIoT system may be designed such that all processes, p_7, p_8, and p_9 may be used by devices, and there may be a semi-static or dynamic configuration of which process to use when performing an access type selection.

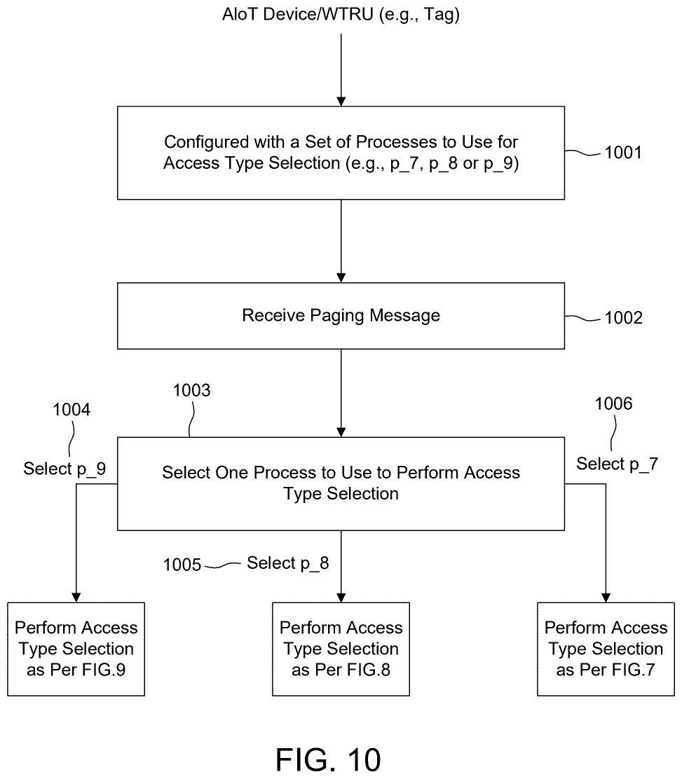

FIG. 10 illustrates a flow chart of an example of a procedure to determine the access type selection process.

The device may be configured or provisioned with a set of possible access type selection processes (processes to select an access type to use, e.g., access type 1 or access type 2). Keeping with the example using FIGS. 7 to 9, processes may be p_7, p_8, or p_9 1001. The device may receive a paging message 1002. The device may choose which process to use from the set of possible processes (p_7, p_8, or p_9) 1003.

The choice of access type selection process may be based on one or more internal conditions of the device. For instance, if the device is in a power boosting constraint state, then process p_9 1004, as described in FIG. 9, may be chosen as the access type selection process, as it includes the power constraint factor.

The choice of access type selection process may be based on one or more external conditions, such as device location, measurement results, or number of devices being paged. The choice may be based on which application is running. The choice may be based on the paging cause (e.g., information provided in the paging message that informs the device the reason for paging). In one example, the device may choose a different process from the set processes for every paging message received, based on paging message contents. In another example, the device may choose a process, and only change the process in case a triggering event occurs.

In one embodiment, the device may be capable of using any of the configured processes (e.g., p_7, p_8, p_9). The WTRU (reader WTRU, intermediate WTRU) may configure the device to use a specific process. The configuration may be static (configured once), semi-static (may be reconfigured), or dynamic: The WTRU may indicate, in a dynamic fashion, which process the device is to use at any given time. For instance, when sending a paging message, the WTRU may include an indication of the process to use, e.g., p_7, p_8, or p_9. Referring to FIG. 10, if the paging message indicates p_9 1004, the device may proceed as per FIG. 9; if the paging message indicates p_8 1005, the device may proceed as per FIG. 8; and if the paging message indicates p_7 1006, the device may proceed as per FIG. 8

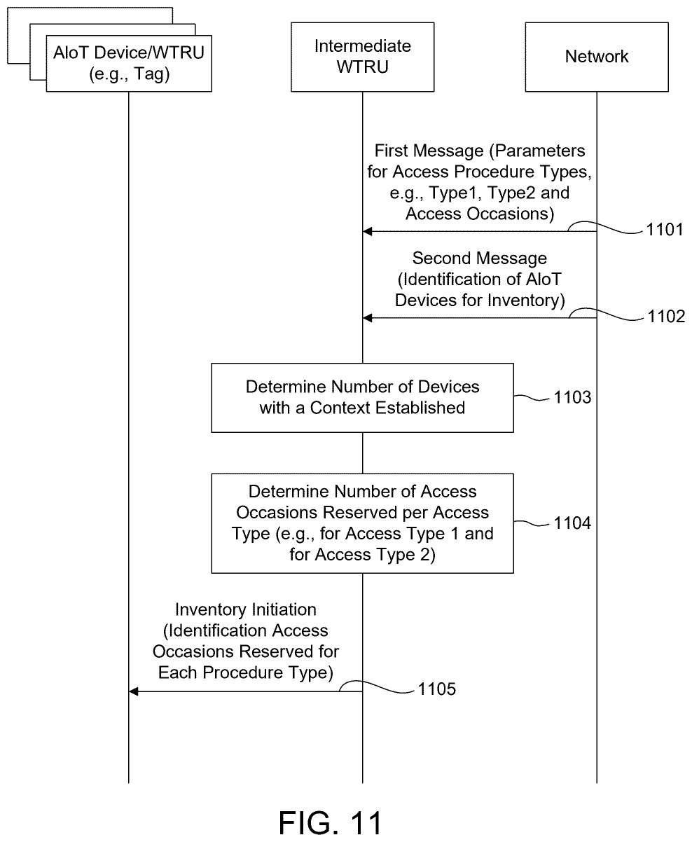

FIG. 11 illustrates a call flow of an example of an intermediate WTRU triggering an inventory procedure.

A WTRU, configured to perform as an intermediate WTRU, a reader, or an interrogator, may receive, from the network, a first message 1101, the first message comprising configuration information associated with one or more access procedure types. The configuration information may include information on parameters associated with one or more access types and information on access occasions and access resources (e.g., frequency, timeslot, symbols)

The WTRU may receive, from the network, a second message 1102, wherein the second message may comprise one or more device identities identifying the devices that are to participate in an inventory.

In one example, the information included in the configuration message and in the inventory request messages may be combined into one message.

The WTRU may determine, from the device identities received in the second message, how many devices already have a context established 1103.

Based on the number of devices with a context established, and on the parameters associated with the access procedure types received in the first message, the WTRU may determine a number of access occasions reserved for access procedures using a first type and a number of access occasions reserved for access procedures using a second type 1104.

In one example, the WTRU may determine a number of access occasions that use a first type of access procedure (e.g., 2-step random access) and a number of access occasions that use a second type of access procedure (e.g., a 4-step random access).

The WTRU may transmit, to the AIoT devices, an inventory initiation message 1105. The inventory initiation message may comprise an indication of the number of access occasions reserved to be used for a first type of access procedure (e.g., 2-step random access) and/or the number of access occasions reserved to be used for a second type of access procedure (e.g., a 4-step random access) 1105.

The inventory initiation message may be a broadcast message to all AIoT devices in proximity, or a multicast message to a sub-set of AIoT devices in proximity, or to a single AIoT device.

In one example, the first type of access procedure may allow data transmissions in the first message that the device sends during the access procedure. For example, devices that already have a context established with the intermediate WTRU may transmit data in the first message. In the other hand, a second type of access procedure may not allow for transmission of data in the first message of the access procedure. Devices may select the first or second procedure to use based, e.g., on whether or not they have a context established with the intermediate UE.

A WTRU may receive, from the network, a first message, wherein the first message may comprise a set of N total access occasions for an inventory round, a threshold factor, TF. The message may also include parameters to be used for determining a number of the access occasions that may be reserved for usage in a first type of access procedure and a number of access occasions that may be reserved to be use for a second type access procedure, e.g., parameters x1 and x2.

The WTRU may receive, from the network, a second message, wherein the second message comprises an inventory request and an indication of devices that are to participate in the inventory procedure. The indication may comprise the identification of the devices that are to participate in the inventory procedure. The identification may include a set of device IDs of a first type and/or device IDs of second type, or an indication of all devices.

In one example, a device ID of a first type is an ID used by the device while the device does not have a context established with the WTRU and a device ID of a second type is an ID assigned by the WTRU when the device establishes a context. The device ID of first type may be a permanent device ID.

The WTRU may, based on the indication of the devices that are to participate in the inventory procedure, determine the number of devices, from all the devices that are to participate in the inventory procedure, that have a context established, wherein a device that has a context established is a device that has previously responded to a request or page from the WTRU and has been assigned, by the WTRU, a device ID of a second type.

The WTRU may determine, based on the number of access occasions for an inventory round (N), the configured threshold factor (TF), and the number of devices that have a context established, a number of the access occasions that may be reserved for usage in a first type of access procedure, and a number of access occasions that may be reserved to be use for a second type access procedure.

In one example, the WTRU may determine if the number of devices that have a context established is less than a threshold factor of the number of access occasions: (number of devices that have a context established)<TF x (number of access occasions). If so, assign x1 access occasions to be used for a first access type. Otherwise, assign x2 access occasions to be used for a first access type. Assign the remaining access occasions, (N-x1) or (N-x2), respectively to be second access type occasions.

In one example, the WTRU may transmit an inventory initiation message to all devices comprising at least one of an indication of the total number of access occasions (N), an indication of the number of access occasions to be used for a first type of access procedure (e.g., the selected x1 or x2). In another example, the WTRU may transmit an inventory initiation message to all devices, including the list of access occasions and an explicit indication of the access procedure type (e.g., first type or second type) associated with each access occasion.

In one example, the devices may select which access occasion to use based on their knowledge of their context in the WTRU. In another example, the message may comprise an identification of the devices that may use access type 1, access type 2, or either access type. The message may be a broadcast. The message may be a multicast. In one example, two messages may be sent, one to devices using access type 1 and another to devices using access type 2, including the access occasions allocated for each.

The identification of the devices may include a list of device IDs of the first type. The identification of the devices may include a list of device IDs of the second type. The identification of the devices may indicate all devices with a device ID of the first type. The identification of the devices may indicate all devices with a device ID of the second first type. The identification of the devices may include a group ID or a set of group IDs. The identification of the devices may indicate all devices with a device ID of the second first type. The identification of the devices may indicate all devices. A combination of these may also be possible.

The WTRU may include in the message an associated mask, wherein the mask indicates the bits of the device ID of the first type and/or of the second type that the device is to use when matching to its own device ID (to check if it is being addressed by the message).

The WTRU may, for a first type of access occasion, transmit, to the device, an occasion initiation message of first type. The WTRU may, for the first type of access occasion, receive, from the device, a response including an access ID and, optionally, data.

The WTRU may, for a second type of access occasion, transmit, to the device, an occasion initiation message of second type. The WTRU may, for the second type of access occasion, receive, from the device, a response including an access ID.

The WTRU may, upon receiving the device ID of first type from the device, select an unused device ID of a second type to assign to the device. The WTRU may send, to the device, a message with the device ID received and the assigned device ID of a second type. The WTRU may store the assigned device ID and its correspondence to the device ID (e.g., the device ID of first type, or a group ID).

The WTRU may receive data from the device.

The WTRU may send, to the network, a third message, wherein the third message comprises one or more device identifications from the ones sent in the second message and their associated assigned device IDs of a second type. The network may use the assigned device IDs of a second type in future inventory requests to the WTRU.

The WTRU may respond to the device. In the response, the WTRU may include a portion of the data it received from the device.

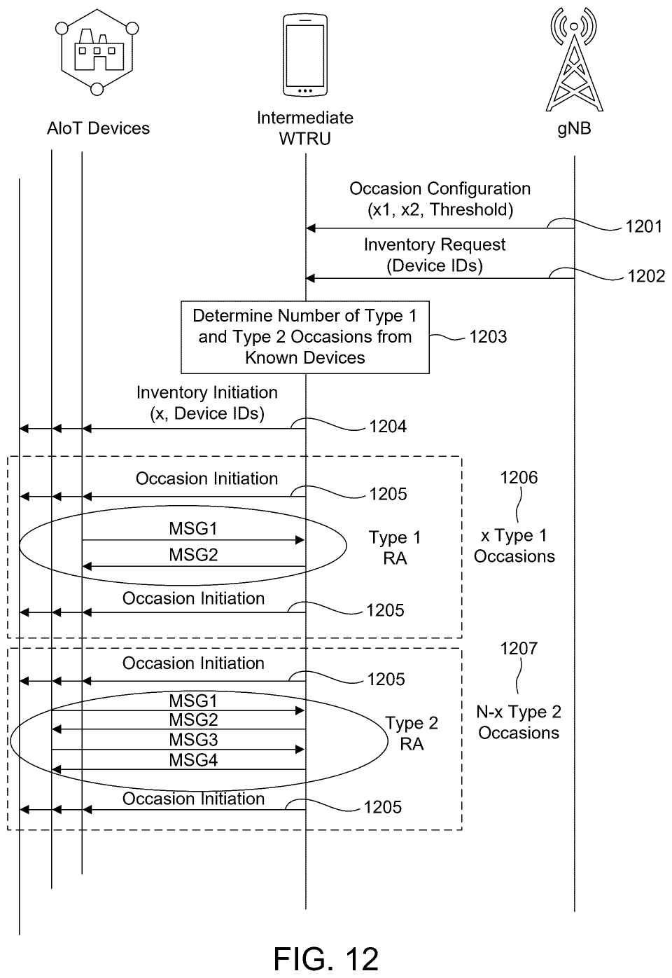

FIG. 12 illustrates a call flow of an example of an intermediate WTRU providing access occasion type configuration during an inventory procedure.

The intermediate WTRU may receive an occasion configuration message from the network which may contain configuration for one or more inventory procedures to be initiated by the intermediate WTRU among a set of AIoT devices 1201.

The intermediate WTRU may receive an inventory request message with a set of device IDs to inventory 1202. This message may be merged (i.e., same message) as the occasion configuration message.

Based on the number of devices that the intermediate WTRU is already aware of (e.g., has already responding to the intermediate WTRU, is being tracked by the intermediate WTRU, etc.), the intermediate WTRU may determine the number of occasions for each access type (x occasions for access type 1, and N-x occasions for access type 2) 1203.

The intermediate WTRU may initiate the inventory procedure by broadcasting one or more messages to all AIoT devices (or by multicasting to a subset of AIoT devices) 1204. The one or more messages may contain the configuration of the occasions, which includes the number of occasions (or the specific occasions) which should be of type 1 or of type 2 and the device IDs. The one or more messages may be one or more paging messages.

The device IDs may be divided into different device ID types. For example, devices which should initiate a type 1 random access procedure may be paged using a short device ID (e.g., an AS layer device ID), while devices which initiate a type 2 random access procedure may be paged using a long device ID (e.g., a NAS layer device ID). Devices which are paged using a short device ID may correspond to devices that are known to the intermediate WTRU, or that the intermediate WTRU is tracking. The intermediate WTRU may translate the device IDs received from the network into the locally assigned and maintained short device IDs and include the short device IDs in the paging message.

Each occasion may be initiated with an occasion initiation message transmitted by the intermediate WTRU 1205.

The first x occasions may correspond to occasions where only type 1 random access is attempted 1206. A device may determine whether to attempt a type 1 random access based on whether it has a stored short (e.g., AS layer) device ID. If so, the device may only attempt random access in the first x occasions 1206.

The next N-x occasions 1207 may correspond to occasions where only type 2 random access is attempted. Devices without a stored short (e.g., AS layer) device ID may attempt access during these occasions 1207.

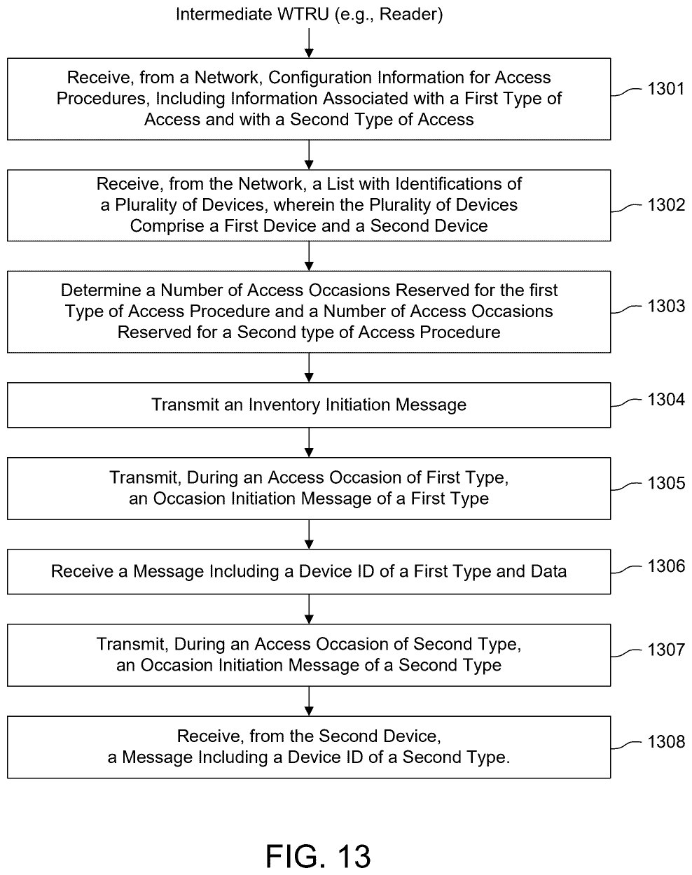

FIG. 13 illustrates an example of a method to be performed by an intermediate WTRU.

The WTRU may receive, from a network, configuration information for access procedures, including information associated with a first type of access procedure and with a second type of access procedure.

The first type of access procedure may be reserved for devices that already have a context established with the WTRU, and, accordingly, it may allow data transmission during the access procedure 1301. These devices may have an ID of first type, which may be associated with their context in the WTRU. The first type of access procedure may not have a contention resolution phase (e.g., 2-step access procedure).

The second type of access procedure may be reserved for devices that do not have a context established with the WTRU. The second type of access procedure may not allow data transmission during the access procedure 1302. These devices may have an ID of second type. The second type of access procedure may have a contention resolution phase (e.g., 4-step access procedure).

The WTRU may receive, from the network, a list with identifications of a plurality of devices, wherein the plurality of devices may comprise a first device and a second device 1302.

The first device may have a device ID of first type. The second device may have a device ID of second type.

The WTRU may determine, based at least on the total number of access occasions for an inventory round and on the number of devices that already have a context established, a number of access occasions reserved for the first type of access procedure and a number of access occasions reserved for a second type of access procedure 1303.

The WTRU may transmit, to the devices identified in list received from the network, an inventory initiation message 1304. The message may include the identifications of a plurality of devices received from the network, including an identification of the first device and an identification of the second device

During an access occasion of first type, the WTRU may transmit an occasion initiation message of first type 1305 and receive, in response, a message from the first device, including a device ID of a first type, and data 1306.

During an access occasion of second type, the WTRU may transmit an occasion initiation message of second type 1307 and receive, in response, a message from the first device, including a device ID of a second type 1308.

The occasion initiation message of first type and the occasion initiation message of second type may be used for device synchronization. The occasion initiation message of first type and the occasion initiation message of second type may be the same type of message (e.g., a synchronization signal), or they may be specific to the type of access procedure (access type 1 versus access type 2)

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, WTRU, terminal, base station, RNC, or any host computer.

What is claimed:

1. A method to be performed by a wireless transmit receive unit (WTRU) configured to perform as an intermediate node, the method comprising:
receiving, from a network, configuration information including first information associated with a first type of access procedure and second information associated with a second type of access procedure;
receiving, from the network, identification of a plurality of devices, wherein the plurality of devices comprise a first device and a second device;
determining, based on the received configuration information and on the received identification of a plurality of devices, access occasions of first type comprising access occasions reserved for accesses using the first type of access procedure;
determining, based on the received configuration information and on the received identification of a plurality of devices, access occasions of second type comprising occasions reserved for accesses using the second type of access procedure;
transmitting, to the devices identified in the received identification of a plurality of devices, an inventory initiation message;
receiving, from the first device, during an access occasion of first type, a message from the first device, wherein the message from the first device includes a first device ID, wherein the first device ID is a device ID of first type; and
receiving, from the second device, during an access occasion of second type, a message from the second device, wherein the message from the second device includes a second device ID, wherein the second device ID is a device ID of second type, and wherein the first type of device ID is different from the second type of device ID.

2. The method of claim 1, wherein the first type of access procedure comprises a 2-step random access procedure and the second type of access procedure comprises a 4-step random access.

3. The method of claim 1, wherein the first type of access does not include a contention resolution phase and the second type of access contains a contention resolution phase.

4. The method of claim 1, wherein the configuration information further comprises an identification of a plurality of access occasions.

5. The method of claim 1, wherein the inventory initiation message comprises at least one of: identification of access occasions of first type, or identification of access occasions of second type.

6. The method of claim 1, further comprising, determining, based on the received identification of a plurality of devices, a number of devices that already have a context established.

7. The method of claim 6, wherein the determination of the access occasions of first type and access occasions of second type is further based on the number of devices that already have a context established.

8. The method of claim 1, wherein the message from the first device further includes data.

9. The method of claim 1, further comprising, selecting, upon receiving the device ID of second type from the second device, a new device ID of first type, and sending, to the second device, a message with the received device ID of second type and the selected new device ID of first type.

10. The method of claim 1, wherein the determination of the access occasions of first type and access occasions of second type is further based on at least one of: measured reference signal received power (RSRP), cause of triggering the access, requirements on the data being requested, capability of the devices being triggered, or location of the devices being triggered.

11. A wireless transmit receive unit (WTRU), the WTRU comprising at least one processor and a transceiver, wherein the at least one processor and transceiver are configured to:
receive, from a network, configuration information including first information associated with a first type of access procedure and second information associated with a second type of access procedure;
receive, from the network, identification of a plurality of devices, wherein the plurality of devices comprise a first device and a second device;
determine, based on the received configuration information and on the received identification of a plurality of devices, access occasions of first type comprising access occasions reserved for accesses using the first type of access procedure;
determine, based on the received configuration information and on the received identification of a plurality of devices, access occasions of second type comprising occasions reserved for accesses using the second type of access procedure;
transmit, to the devices identified in the received identification of a plurality of devices, an inventory initiation message;
receive, from the first device, during an access occasion of first type, a message from the first device, wherein the message from the first device includes a first device ID, wherein the first device ID is a device ID of first type; and
receive, from the second device, during an access occasion of second type, a message from the second device, wherein the message from the second device includes a second device ID, wherein the second device ID is a device ID of second type, and wherein the first type of device ID is different from the second type of device ID.

12. The WTRU of claim 11, wherein the first type of access procedure comprises a 2-step random access procedure and the second type of access procedure comprises a 4-step random access.

13. The WTRU of claim 11, wherein the first type of access does not include a contention resolution phase and the second type of access contains a contention resolution phase.

14. The WTRU of claim 11, wherein the configuration information further comprises an identification of a plurality of access occasions.

15. The WTRU of claim 11, wherein the inventory initiation message comprises at least one of: identification of access occasions of first type, or identification of access occasions of second type.

16. The WTRU of claim 11, wherein the at least one processor and transceiver are further configured to determine, based on the received identification of a plurality of devices, a number of devices that already have a context established.

17. The WTRU of claim 16, wherein the determination of the access occasions of first type and access occasions of second type is further based on the number of devices that already have a context established.

18. The WTRU of claim 11, wherein the message from the first device further includes data.

19. The WTRU of claim 11, wherein the at least one processor and transceiver are further configured to select, upon receiving the device ID of second type from the second device, a new device ID of first type, and send, to the second device, a message with the received device ID of second type and the selected new device ID of first type.

20. The WTRU of claim 11, wherein the determination of the access occasions of first type and access occasions of second type is further based on at least one of: measured reference signal received power (RSRP), cause of triggering the access, requirements on the data being requested, capability of the devices being triggered, or location of the devices being triggered.
